(19) United States
(12) Patent Application Publication
(10) Pub. No.: US 2015/0247971 A1
(43) Pub. Date: Sep. 3, 2015

(54) METHODS OF MANUFACTURE OF CONTINUOUS RESONANT TRAP STRUCTURES, SUPPORTING STRUCTURES THEREOF, AND DEVICES USING SAME

(71) Applicant: SOLARSORT TECHNOLOGIES, INC, Barrington, RI (US)

(72) Inventors: Shalom Wertsberger, Rochester, NY (US); Jeffrey C. Andle, Falmouth, ME (US)

(21) Appl. No.: 14/426,718

(22) PCT Filed: Sep. 10, 2013
(86) PCT No.: PCT/US13/59044

§ 371 Date: Mar. 6, 2015

Related U.S. Application Data
(63) Continuation-in-part of application No. 13/726,044, filed on Dec. 22, 2012, now Pat. No. 8,532,448.
Application No. 13/726,044 is a continuation-in-part of application No. 13/685,691, filed on Nov. 26, 2012, now Pat. No. 8,530,825.
Application No. 13/685,691 is a continuation-in-part of application No. 13/831,575, filed on Mar. 14, 2013.
(60) Provisional application No. 61/701,687, filed on Sep. 16, 2012.
(60) Provisional application No. 61/713,602, filed on Oct. 14, 2012.
(60) Provisional application No. 61/718,181, filed on Oct. 24, 2012.
(60) Provisional application No. 61/723,832, filed on Nov. 8, 2012.
(60) Provisional application No. 61/724,920, filed on Nov. 10, 2012.
(60) Provisional application No. 61/801,619, filed on Mar. 15, 2013.
(60) Provisional application No. 61/801,431, filed on Mar. 15, 2013.
(60) Provisional application No. 61/786,357, filed on Mar. 15, 2013.
(60) Provisional application No. 61/723,773, filed on Nov. 7, 2012.

(30) Foreign Application Priority Data
Dec. 14, 2012 (GB) 1222557.9

(51) Int. Cl. G02B 6/13; G02B 6/136; G02B 6/122

(52) U.S. Cl. CPC G02B 6/13; G02B 6/1228; G02B 6/136; G02B 6/1225; G02B 2006/12176

(57) ABSTRACT

Methods for creating Continuous Resonant Trap Refractors (CRTR's), and methods for creating stratum structure in which the CRTR is to be disposed, are disclosed The invention further include novel methods for patterning an etch mask, and forming collimators of adjustable length.

### RELATED APPLICATIONS

Aspects of the present invention were first disclosed in U.S. Patent Application 61/701,687 to Andle and Wertsberger, entitled “Continuous Resonant Trap Refractor, Waveguide Based Energy Detectors, Energy Conversion Cells, and Display Panels Using Same”, filed 16 Sep. 2012. Further refinements of the tapered waveguide based Continuous Resonant Trap Refractor (CRTR) and to lateral waveguides with which CRTRs may cooperate, were disclosed together with various practical applications thereof in the following additional U.S. Patent Applications: 61/713,602, entitled “Image Array Sensor”, filed 14 Oct. 2012; 61/718,181, entitled “Nano-Scale Continuous Resonance Trap Refractor”, filed 24 Oct. 2012; 61/723,832, entitled “Pixel Structure Using Tapered Light Waveguides, Displays, Display Panels, and Devices Using Same”, filed 8 Nov. 2012; 61/723,773, entitled “Optical Structure for Banknote Authentication”, filed 7 Nov. 2012; Ser. No. 13/726,044 entitled “Pixel Structure Using Tapered Light Waveguides, Displays, Display Panels, and Devices Using Same”, filed 22 Dec. 2012; Ser. No. 13/685,691 entitled “Pixel structure and Image Array Sensors Using Same”, filed 26 Nov. 2012; Ser. No. 13/831,575 entitled “Waveguide Based Energy Converters, and energy conversion cells using same” filed Mar. 15, 2013; 61/786,357 titled “Methods of Manufacturing of Continuous Resonant Trap Structures, Supporting Structures Thereof, and Devices Using Same” filed Mar. 15, 2013, 61/801,619 titled “Tapered Waveguide for Separating and Combining Spectral Components of Electromagnetic Waves” filed Mar. 15, 2013, U.S. 61/801,431 titled “Continues Resonant Trap Refractors, lateral waveguides, and devices using same” filed Mar. 15, 2013, all to Andle and Wertsberger; and 61/724,920, entitled “Optical Structure for Banknote Authentication, and Optical Key Arrangement for Activation Signal Responsive to Special Light Characteristics”, filed 10 Nov. 2012, to Wertsberger. Furthermore Patent application GB 1222557.9 filed Dec. 14, 2012 claims priority from U.S. 61/701,687. All of the above-identified patent applications are hereby incorporated herein by reference in their entireties.

### FIELD OF THE INVENTION

The present invention relates generally to methods of creating photonic structure in supporting environs, and more particularly to methods, systems and materials for manufacturing of Continuous Resonant Trap refractors (CRTR's) and lateral waveguides.

### BACKGROUND

Optical waveguides may be roughly divided into dielectric and reflective waveguides. In dielectric waveguides, a dielectric core of high index of refraction is surrounded by a dielectric cladding of lower refractive index. In a reflective waveguide the core is surrounded by a highly reflective cladding such as metal. The term cladding should be construed to include both a dielectric, as well as metallic elements, compounds, and other reflective materials. Both constructs confine the wave energy and therefore ‘guides’ it in a certain path, and both constructs act similarly for very high frequency waves, ranging from the microwave and Extreme High Frequency (EHF), Infra Red (IR) to the deep Ultra Violet and beyond.

Waveguides have a cutoff frequency, which is dictated by the wave velocity in the waveguide materials, and the waveguide width. As the frequency of the energy propagating in the waveguide approaches the cutoff frequency Fc, the energy propagation velocity along the waveguide is slowed down.

The energy propagation of a wave along a waveguide may be considered as having an angle relative to cladding. This angle is determined by the relationship between the wavelength of the wave and the waveguide width in the dimension in with the wave is being guided. If the width of the waveguide equals one half of the wave wavelength, the wave reaches resonance, the energy propagation along the waveguide stops, and the angle may be considered as 90°. In a dielectric waveguide, the wave energy would reach a critical angle prior to 90° and the energy would depart the waveguide via the cladding. In a perfectly reflective waveguide, the wave may be trapped. If however the cladding is sufficiently thin, or alternatively the cladding is perforated, the energy can still penetrate the cladding at or near the place of resonance. Notably a metallic cladding of lower thickness than the penetration depth to which the cladding is exposed would allow some energy to pass therethrough and such cladding may be utilized. Furthermore, when certain metals are disposed at low thicknesses they tend to ‘ball-up’ and form small ‘islands’. Such perforated metal, and intentionally perforated metals may form the reflective cladding.

A Continuous Resonant Trap Refractor (CRTR) is the name used in these specifications to denote a novel structure which is utilized in many aspects of the present invention. As such, a simple explanation of the principles behind its operation is appropriate at this early stage in these specifications, while further features are disclosed below.

A CRTR is a structure based on a waveguide having a tapered core, the core having a wide base face forming an aperture, and a narrower tip. The core is surrounded at least partially by a cladding which is transmissive of radiant energy under certain conditions. The CRTR may be operated in splitter mode, in a mixer/combiner mode, or in a hybrid mode providing combination of mixer and splitter mode. In splitter mode the radiant energy wave is admitted into the CRTR via the aperture, and travels along the depth direction extending between the aperture and the tip. The depth increases from the aperture towards the tip, such that larger depth implies greater distance from the aperture. The core is dimensioned such that at least some of the admitted frequencies will reach a state where they will penetrate the cladding, and be emitted therefrom. This state is referred to as Cladding Penetration State (CPS), and is reached when energy of a certain frequency approaches a critical width of the waveguide for that frequency. The mechanism at which cladding penetration state occurs may vary, such as by tunneling penetration, skin depth penetration, a critical angle of incidence with the cladding and the like. Generally CPS will occur in proximity to, or at the width, where the wave reaches a resonance, known as the critical frequency for that width, and conversely as the critical width for the frequency, of the wave. Regardless of the mechanism, a CPS is characterized by the wave reaching a frequency dependent depth within the CRTR where it is emitted via the cladding. The decreasing width of the core will dictate that a lower frequency wave will reach CPS before higher frequency waves, and will penetrate the cladding and exit the waveguide at a shallower depth than at least one higher frequency wave. As waves of differing frequencies will be emitted via the cladding at differing depths, the CRTR will provide spatially separated spectrum along its cladding. Notably, in certain CRTR embodiments some frequency components of the incoming energy may be emitted via the tip, in non-sorted fashion.

Conversely, when operated in mixer/combiner mode, a wave coupled to the core via the cladding, at, or slightly above, a depth where it would have reached CPS in splitter mode, will travel from the emission depth towards the aperture, and different waves coupled to the core through the cladding will be mixed and emitted through the aperture. Coupling energy into the CRTR core from the cladding, will be referred to as ‘injecting’ or ‘inserting’ energy into the CRTR. It is noted that in most if not all practical cladding materials the energy will refract when entering and exiting the cladding. Therefore, the energy source will be located at a different depth than the point of desired entry into the core. The depth at which the wave would couple into the tapered core is somewhat imprecise, as at the exact depth of CPS the wave may not couple best into the core, thus the term ‘slightly above’ as referred to the coupling of light into the tapered core in combiner/mixer mode should be construed as the depth at which energy injected into tapered core via the cladding would best couple thereto to be emitted via the aperture, within certain tolerances stemming from manufacture considerations, precision, engineering choices and the like.

The term spectral component will relate to energy portion of the energy at the aperture, which is characterized by its frequency, polarization, phase, flux, intensity, incidence, radiosity, energy density, radiance, or a combination thereof.

A round cross section of the tapered core will be polarization neutral under most circumstances. Certain non-symmetrical or multi-faceted symmetrical tapered core forms will however cause separation of the aperture-admitted radiant energy to be polarization sensitive. Thus, by way of example, a square pyramid or frustum CRTR core will separate incoming radiant energy into its component polarizations as well as by its frequency. Thus if two transducers are disposed in a first and a second path of energy emitted via the cladding, the first path exits the core at a first face, and second path exists the core at a second face disposed at an angle to the first face, the first transducer will receive a spectral component which differs from the spectral component received by the second face, at least by different polarization. This behavior will be reversed when the CRTR operates in mixer/combiner mode, such that energy emitted from the aperture will reflect the polarity created by separate sources, and injected into the CRTR at different faces. By way of none-limiting example, if light source A injects modulated energy into one face of the pyramidal core, and light source B injects differently modulated energy into a perpendicular face of core, the light emitted by the aperture will have one spectral component at a first polarization reflecting the modulation of source A, and a second spectral component at 90° to the first spectral component, representing the modulation of source B. Therefore, placing a plurality of EL transducers at different angular locations about the depth dimension of the CRTR, would result in combined polarized energy corresponding to the location of the transducers, being emitted via the aperture, when the transducers are energized.

Transducers are disposed about the cladding. The term “about the cladding” or equivalently about the CRTR or its core, should be construed to mean being coupled to via energy path, which implies that the transducer is disposed about the cladding not only by being physically adjacent to the cladding, but also when an energy path such as beam propagation, waveguide, and the like, exists between the location where energy is transferred in or out of the cladding, and the transducer. Similarly, the disposition about the cladding is set by the location at which the energy exists or enters the cladding. Thus, by way of example if the transducer is coupled to the cladding via a waveguide such that the energy couples at depth A of the CRTR, the transducer is considered to be disposed at depth A regardless of its physical location relative to the CRTR. Similarly, the concept of having two transducers disposed at angle therebetween, such as when required to distinguish between different polarities, the point where the energy exits or enters the cladding is considered where the transducers are disposed at, even if the energy is otherwise directed to transducers that are physically elsewhere, such as by way of waveguides, mirrors, and the like.

CRTRs may also operate in reflective mode, by providing light gates, which will reflect radiant energy back into the CRTR tapered core. A light gate disposed at the depth where radiant energy is emitted out of the cladding, will cause the emitted energy to be reflected back into the cladding, and thence emitted via the aperture. An array of CRTRs in conjunction with RL transducers which act as light-gates will have variable reflectivity such that at least a portion of the radiant energy incident on the array at the associated frequency will be reflected, in accordance with the setting of the light gate reflectors. The term light gate should be construed to a device able of controlling radiant energy passage or block, absorption, reflectance, and the like, across a spectral range of interest, which may extend beyond the visible range. The spectral range of interest is dictated by the application at hand. The broad band capabilities of the CRTR allows modulation of its reflectance over a broad band of frequencies, extending the ability for reflectance into the UV, IR, and even the mm wave spectrum. Reflective mode may also operate in polarization sensitive mode as explained above for EL and LE transducers in polarization sensitive mode.

A CRTR is considered to operate in hybrid mode when energy is both admitted and emitted via the aperture. In certain embodiment this mode involves energy being admitted via the aperture and at least portions thereof being emitted via the cladding, while other energy is being injected via the cladding and emitted via the aperture. In other embodiments a portion of the energy admitted via the aperture is selectively reflected back therethrough. A reflective CRTR is a CRTR cooperating with at least one RL transducer, and is also considered to operate at hybrid mode.

Thus functionally, a CRTR is a device which allows passage of radiant energy therethrough, while
a. imparting a change in the direction of propagation of incoming energy;
b. in one mode a CRTR is operational to spatially disperses incoming energy into spatially separated spectral components thereof, which are outputted via the CRTR cladding, the mode is equivalently referred to as disperser, splitter, or dispersion mode;
c. in another mode a CRTR is operational to combine a plurality of incoming spectral

components into emitted energy comprising the components and emitted via the aperture, the mode equivalently referred to as combiner, mixer, or mixing mode; and,
d. in another mode the CRTR is operational to controllably reflect at least a portion of the spectral components admitted via the aperture, the reflected components being reflected via the aperture, thus controllable changing the effective reflectance of the CRTR at selected spectral components, the mode equivalently referred to as reflective mode or reflectance mode.
As presented elsewhere in these specifications, a CRTR may be operated in a combination of these modes, and such mode is considered a hybrid mode.

The CRTR aperture is thus dimensioned, when operating in splitter mode, to allow the entry of a spectral component having at least the lowest frequency in the spectral range of interest, which means that the longest wavelength in the spectral range of interest for the CRTR is defined by the aperture width in at least one dimension. Notably, the spectral range of interest may be limited by other considerations to shorter wavelengths. The core taper in at least one dimension which must encompass both the emission width of the longest wave in the spectral range of interest as well as an emission width of at least one shorter wavelength within the spectral range of interest. The CRTR either will taper to less than the emission width of the shortest wave in the spectral range of interest or will allow the final portion of the spectral range of interest to exit vertically at a truncated tip of the core. Larger widths than those emission widths at the inlet aperture, or smaller widths than those emission widths at the tip, are allowed.

If the tip is truncated or otherwise allows passage of at least some of the spectral components that were admitted by the aperture, the highest frequency in the spectral range of interest for the CRTR is defined by the longest wavelength that will be emitted via the cladding. If the tip does not allow energy to pass therethrough, the highest frequency in the spectral range of interest for the CRTR is the highest frequency to be emitted via the cladding, and detected or reflected by any desired manner.

The spectral range of interest for a CRTR operated in mixer mode is the range between the highest and lowest frequencies of radiant energy injected into the tapered core via the cladding. In hybrid and reflective modes of operation the spectral range of interest for the CRTR is a combination of the above ranges, as dictated by the application at hand. Notably, all of those spectral ranges of interest are defined for the CRTR. Portions of the CRTR or other elements of the invention may have different ranges of interest.

A simplified view of a CRTR is provided in FIG. 1. A CRTR comprises a tapered core waveguide having a tapered core 73 and a cladding 710; the core having an aperture and a tip. The larger face (denoted Hmax) of the tapered waveguide core will be generally referred to as the CRTR aperture, and the smaller face, which may taper to a point, will generally be referred to as the tip. The axis X-X extending between the aperture and the tip would be referred to as the CRTR depth axis. Radiant energy 730 admitted via the aperture travels generally along the depth axis; however, the energy may travel towards the aperture in mixer mode, away therefrom in splitter mode, or in both direction in any hybrid mode. In splitter mode a CRTR admits energy within a spectral range of interest via the aperture and emits it in a frequency sorted fashion via the cladding. A CRTR operating in mixer mode admits radiant energy via the cladding and mixes and emits the energy via the aperture. Notably, a certain angle shift occurs in the process, and thus, energy entering the CRTR from its aperture will be angled away, i.e. refracted, and emitted at an angle to the depth dimension in a splitter mode. In mixer mode energy entering the CRTR via the cladding will couple to the core and would be angled away from the direction in which it was injected, to propagate generally along the depth axis and emitted via the aperture. The CRTR has a width dimension in at least one direction substantially perpendicular to the depth axis. The core width varies in magnitude so as to be greater at the first end than at the second end. The core width is also dimensioned such that when multi-frequency energy is admitted through the core and propagates along the core depth, it will cause a lower frequency spectral component to reach a cladding penetration state at a first depth, and the core will further taper to a width that will cause energy of a higher frequency spectral component reach a cladding penetration state at a second depth, which is larger than the first depth. In most embodiments, this is achieved by having the width dimension taper to a size smaller than half wavelength of the shortest wave in the spectral range of interest of the CRTR, but in certain embodiments a portion of the spectral range of interest is emitted via the tip.

At its wider base known as the aperture, the CRTR has a width Hmax, which limits the lowest cutoff frequency Fmin. At the tip the tapered core width Hmin dictate a higher cutoff frequency Fmax. Between the aperture wide inlet and the narrower tip, the cutoff frequency is continually increased due to the reduced width. Radiant energy 730, such as polychromatic light is incident the aperture at an angle which permits energy admission. Waves having a lower frequency than the cutoff frequency Fmin are reflected 735. Waves 740 having frequency higher than Fmax exit through the CRTR core, if an exit exists. Waves having frequencies between Fmin and Fmax will reach their emission width, and thus their cladding penetration state, at some distance from the inlet of the waveguide depending on their frequency. The distance between the inlet and the emission width of a given frequency is the emission depth.

Thus, examining the behavior of a wave of arbitrary frequency Ft, where Fmin<Ft<Fmax, which enters into the CRTR core at its aperture at an incidence angle within an acceptance cone centered about the propagation axis X-X, the angle θ between the wave and X-X will vary as the wave propagates along the X-X axis due to the narrowing of the CRTR waveguide and increase of the cutoff frequency, as depicted schematically by Ft′. As the wave approaches depth X(Ft) where either the tapered waveguide cutoff frequency equals or nearly equals Ft, or the angle θ approaches the critical angle θC, at which the wave can not propagate any further within the CRTR core. The wave Ft is thus either radiated through the dielectric cladding of the CRTR as shown symbolically by 750 and 752, or is trapped in resonance at depth X(Ft) in a metal clad CRTR. At that point the wave of frequency Ft reached its cladding penetration state at the emission depth dictated by the emission width of the tapered CRTR core. For a continuum of entering waves of different frequencies Fmin<F1, F2, . . . Fx<Fmax, entering the base of the tapered waveguide 71, it becomes a Continuous Resonant Trap Refractor (CRTR) in which the different frequency waves become standing waves, trapped at resonance in accordance to their frequency along the X-X axis. Such trapped waves are either leaked through the cladding by the finite probability of tunneling though the cladding or are lost to absorption in the waveguide. Note that since a CRTR will in general also cause admitted rays (speaking from the perspective of a CRTR operating in splitter mode) to be refracted or otherwise redirected so that the component(s) produced by splitting exit the CRTR at an angle to the CRTR depth axis, this will make it possible to employ a CRTR that has been embedded within stacked waveguides in such a manner that the CRTR directs specific components, e.g., spectral components, of the incoming multispectral radiation to predetermined waveguides.

Therefore, for a given CRTR spectral range of interest Si, ranging between λmax to λmin which represent respectively the longest and shortest wavelengths of the spectral range of interest as measured in the core material, wherein λ′ is at least one wavelength in Si, the dimensions of a frequency splitting CRTR taper are bounded such that

a. the aperture size must exceed the size of one half of Amax;
b. the CRTR core size must also be reduced at least in one dimension, to at least a size ζ which is smaller than or equal to one half of wavelength λ′.

Thus the CRTR dimensions must meet at least the boundary of

{λ′/2≦λmax/2≦ψ} where the CRTR sizes defined above relate to a size in at least one dimension in a plane normal to the depth dimension. In FIG. 4 the aperture size ψ=hmax. It is noted however that not all waves in Si must meet the condition b. above. By way of example, certain waves having shorter wavelengths than hmin/2 may fall outside the operating range of the CRTR. Such waves which enter the CRTR will either be emitted through the tip, reflected back through the aperture, or absorbed by some lose mechanism.

Notably if a third spectral component λ′ is present, and has a higher frequency than λ′, it may be emitted at greater depth than λ′ or be emitted or reflected via the tip, if the tip is constructed to pass a spectral component of frequency λ″.

It is noted that CRTR use may extend to the millimeter wave range (EHF), or even to the microwave range. Between cm waves and micron IR radiant energy the range of available dielectric constants increases dramatically. By way of example, water has an index of refraction of nearly 10 at radio frequencies but only 1.5 at IR to UV. There are numerous optical materials with low and high index at mm wave frequencies and below. Thus while the principles of operation of CRTRs are similar, the materials and sizes differ. A millimeter/microwave operated CRTR is a channelized filter integrated into a horn antenna wherein the channelized ports are lateral to the horn and the in-line exit port is a high pass filtered output for a broad band input. Such device may be utilized as a an excellent front end for a multiplexer/diplexer, and as a general purpose antenna that has excellent noise figure and improved anti-jamming as those characteristics are determined at the front en of devices which use them.

Structure to facilitate conversion of radiant energy to electricity or electrical signals (hereinafter “LE”), or conversion of electrical signals into radiant energy such as light (hereinafter “EL”) are known. Collectively, objects, materials, and structures, which perform conversion between two forms of energy, or adjust and control flow of energy, are known by various names which denote equivalent structures, such as converters, transducers, absorbers, detectors, sensors, and the like. To increase clarity, such structures will be referred to hereinunder as ‘transducers’. By way of non-limiting examples, the term “transducer” relates to light sources, light emitters, light modulators, light reflectors, laser sources, light sensors, photovoltaic materials including organic and inorganic transducers, quantum dots, CCD and CMOS structures, LEDs, OLEDs, LCDs, receiving and/or transmitting antennas and/or rectennas, phototransistors photodiodes, diodes, electroluminescent devices, fluorescent devices, gas discharge devices, electrochemical transducers, and the like.

A transducer of special construction is the RL transducer, which is a reflective transducer. Reflective transducers controllably reflect radiant energy. Such transducers may comprise micro-mirrors, light gates, LCD, and the like, positioned to selectively block the passage of radiant energy, and reflect it into a predetermined path, which is often but not always, the general direction the energy arrived from. Certain arrangements of semiconductor and magnetic arrangements may act as RL transducers by virtue of imparting changes in propagation direction of the radiant energy, and thus magnetic forces or electrical fields may bend a radiant frequency beam to the point that in effect, it may be considered as reflected. RL transducers may be fixed, or may be used to modulate the energy direction over time.

The skilled in the art would recognize that certain LE transducers may act as EL transducers, and vice versa, with proper material selection, so a single transducer may operate both as EL and LE transducer, depending on the manner of operation. Even certain RL transducers may act as another transducer type. Alternatively transducers may be built to operate only as LE, as RL, or as EL transducers. Furthermore, different types of transducers may be employed in any desired combination, so the term transducers may imply any combinations of LE, EL, and RL, as required by the application at hand.

The outer cladding of the CRTR is commonly disposed, at least in part, within a stratum. The stratum may be disposed on top of a substrate if one is used. Additional materials may be disposed on top of the stratum, such as anti-reflective layers, protective layers, collimation layers, lenses, and the like. Stratums may be roughly divided into slab stratum and a layered stratum and the selection of the type of stratum is a matter of technical choice. Certain layered stratums are formed as a plurality of superposed waveguides, know as lateral waveguides. Lateral waveguides may be dimensioned with different thicknesses, to accommodate guiding of waves of differing frequencies. The cladding of lateral waveguides is generally made of reflective and conductive material such as metal or a metallic compounds or alloys, however certain non-metallic conductors may be used. With respect to the lateral waveguide cladding the term metal cladding will be used to cover any conductive material of which the cladding is made.

The stratum may also contain one or more transducers, which for certain applications are also frequency-selective and/or frequency-optimized. Combinations of EL LE, and RL transducers may be utilized as required by the application at hand. Such transducers may be included in layered or non-layered stratums.

A lateral waveguide has at least one aperture thru which energy is admitted. The aperture admits energy along the axis defined by the local plan of the core and the cladding, or stated differently through an edge, as opposed to via the cladding. The edge may be an actual edge of the lateral waveguide sheet but it is more often the location at which the waveguide and the CRTR or the CRTR surrounding matter meet. In some embodiments the edgewise opening and waveguide material may be inclined to the waveguide plan, but as the energy would enter or depart the lateral waveguide through its edge, the lateral waveguide aperture size should be construed to be the waveguide thickness at the first instance where a wave entering the guide would propagate between the two cladding layers.

A lateral waveguide also has its own local spectral range of interest SL, which ranges from a low limit frequency minimum F_{Lmin} to high limit F_{Lmax}. Generally F_{Lmax} is a matter of technical choice but as a general guideline, it is proposed that in a stack of lateral waveguides, a single lateral waveguide would extend to the minimum frequency F_{Lmin} of the waveguide having the adjacent spectral range of interest.

In lateral waveguides having EL type transducers, it is often desirable to slow down the energy propagation in order to achieve longer effective length along the transducer. In certain embodiments containing such transducers, F_{Lmin} is the lowest frequency wave having sufficient energy level for removing electrons in the transducer from a valence band to the conduction band. The lateral waveguide aperture size in such embodiments is slightly higher than half the wavelength λ_{Lmax} of F_{Lmin} to admit such wave into the lateral waveguide. It is desirable to follow closely the guidance of slightly larger λ_{Lmax}/2 guideline for the aperture size in order to maximize the waveguide effective length, however tight tolerances are often impractical due to manufacturing tolerances, cost consideration, and the like. Thus a very wide range of aperture size is acceptable, and the waveguide should be considered to slow the propagation speed significantly if it provides propagation speed ranging from 90% or slower of the energy propagation speed in the unrestricted waveguide material. 50% is desired, and slower ranges such as 25%, 10%, and the like are preferred.

Layers and portions of the stratum may be formed as a single undivided layer, or may be divided into sections. Sections may be separated electrically and/or optically from each other, and the barriers between the different sections will generally be referred to hereinunder as ‘baffles’. A common division is to provide baffles to separate the region around a single CRTR and thus create a single CRTR based pixel, however divisions containing more than one CRTR may exist. A CRTR based pixel may be an emitting pixel for emitting radiant energy, a sensing pixel for sensing and/harvesting energy, a reflective pixel for selectively reflecting energy admitted via the aperture back therethrough, or a combination thereof. The stratum may also comprise circuitry such as conductors, vias, and the like as required for connecting individual pixels. The stratum may also contain active and passive electronic components, such as amplifiers, controllers, switches, and the like. In certain embodiments the stratum may comprise inactive layers.

The stratum material is a matter of technical choice; however good reproducibility of its index of refraction, capability of being deposited at sub-micron to micron-scale thicknesses with good uniformity, precise thickness control, and low stress are highly desired, as are good adhesion to the substrate and compatible thermal properties. Spin on glasses, such as polymethylsiloxanes, polymers such as polymethylmethacrylate (PMMA) and parylene, oxides and nitrides, such as silicon-aluminum oxy-nitride (SiₐAl_{b}O_{c}N_{d}, including Sialon®) and the like are all potential stratum material. The skilled in the art would recognize many other well-known materials providing the desired properties.

The cladding of the CRTR's and/or the lateral waveguides may comprise a plurality of materials and may be deposited in several stages. Aluminum, silver, copper, and gold are among the many candidate metals that are highly reflective, electrically efficient and chemically stable, although numerous other examples are readily considered. At optical frequencies the skin depth is on the order of 1-5 nm and thicknesses of continuous metallic claddings would be on or below this order. Use of metallic claddings imposes few constraints on the core material other than thermal compatibility and transparency over the spectral range of interest. Some metals form discontinuous films on some substrates even at thicknesses in excess of the skin depth. Such discontinuous (porous or perforated) metal films are also known to be semi-transparent near normal incidence at thicknesses approaching tens of nm, and such discontinuous metal cladding is also considered. Furthermore, certain metals may short items in the stratum, and insulating materials may need to be deposited to prevent such occurrences.

Cladding may also be a low refractive index dielectric material, polymers, and the like. Silicon dioxide, Parylene-N, are but two possible examples should the by way of example. Efficient total internal reflection of the radiant energy in the CRTR core suggests that the core have higher refractive index than the cladding and that the cladding have a minimum thickness sufficient to totally internally reflect the wave until approximately the critical angle, at which a cladding penetration state is abruptly reached.

Efficient manufacturing of CRTR's and certain stratum constructions, present different requirements according to the application. In certain applications cost is the controlling factor, while lower precision, repeatability and the like are tolerated. In other applications the cost is secondary to the function, while precision is of utmost importance. Therefore there is a clear, and heretofore unmet, need for a number of manufacturing methods for CRTR's and stratum.

### SUMMARY

Thus, it is an object of the present invention to provide methods of manufacturing and optional materials for stratum and CRTR's in various combinations and types; the combination will answer a plurality of needs.

To that end there is provided a method of making a stratum having a plurality of superposed lateral waveguides, the method comprising the steps of providing at least a first and a second waveguides disposed at least partially in superposed relationship therebetween, and further providing a core layer for at least one of the lateral waveguides, and providing an upper and a lower metal cladding layers disposed respectively on opposite sides of the core layer, wherein the core comprises materials selected from optical dielectric material, conductive material, semiconductor material, electron donor material, electron acceptor material, and any combination thereof. The material of the core layers is substantially transparent to the energy impinging thereupon. Each lateral waveguide is directed in use to receive or emit at least one spectral component in a waveguide specific spectrum of interest.

Lateral waveguides are generally planar, which means that when the waveguides are laid on a plane, the thickness dimension is perpendicular to the plane, and the thickness has significantly smaller magnitude at least one of the dimensions parallel to the plane.

Optionally the core layers comprise at least one transducer. In certain embodiments the transducer comprises an electron donor and an electron acceptor.

Optionally, at least one of the lateral waveguides has a transducer disposed therein, the transducer having bandgap energy slightly higher than the energy associated with radiation of the lowest frequency which can propagate in the waveguide. Further optionally at least a first and a second of the plurality of the superposed waveguides each having a transducer disposed therein, wherein the transducer disposed in the first waveguide having a different bandgap energy than the bandgap energy of the transducer disposed in the second waveguide, where each of the waveguide having a different waveguide specific spectrum of interest, such that in use each if the two lateral waveguides receive or emit at least one spectral component in the waveguide specific spectrum of interest.

In certain embodiments an intrinsic material is deposited between the electron donor and the electron acceptor. In certain embodiments charge transport layers may be disposed between the first cladding layer and the electron donor layer, and/or between the second cladding layer and the electron acceptor layer.

In energy harvesting embodiments having transducers layered within the waveguide, the preferred cladding layers comprise metal layers. Optionally an insulator is disposed between the metal layer of one waveguide and the waveguide disposed thereabove. In other embodiments the metal layers of two adjacently superposed waveguides may be formed by a single metal layer. In some embodiments the detectors within the waveguides are arranged to have the same polarity, and in some they are arranged to have opposite polarity. The term polarity refers to the fact that the metal layer closer to the electron donor of a waveguide is considered an anodic layer and the metal layer closer to the electron acceptor of the waveguide is consider a cathodic layer. Stated differently in same polarity arrangement an electron acceptor layer of the first cell would be closer to the electron donor layer of the superposed waveguide than to the electron acceptor thereof, and in opposing polarity, the electron acceptor layer of one waveguide would be closer to the electron acceptor layer of a superposed cell, then to the electron donor thereof.

Optionally, the electron donor layer of one of the lateral waveguide is of differing energy bandgap than the energy bandgap of the electron donor layer of the superposed waveguide. Further optionally, the bandgap energy level of the differing lateral waveguides would increase with increased distance from the aperture of a CRTR embedded within the plurality of lateral waveguides forming the stratum.

Optionally the method further comprises disposing a buffer layer superposed the plurality of waveguides.

Further optionally the method comprises disposing a plurality of baffles for partitioning at least one of the waveguides into a plurality of sectors.

Another aspect of the invention provides methods for forming a Continuous Resonant Trapping Refractors (CRTR's) in a stratum.

In one embodiment the method comprises forming pits within the stratum, the pits having walls, disposing CRTR core material at least partially within the pit and disposing cladding material between the CRTR core and at least one wall. Notably the order of the steps of disposing the cladding and disposing the CRTR core is embodiment dependent, and such steps may occur at any desired order, or even simultaneously.

In some embodiments metal cladding is utilized, such that the cladding comprises a metallic layer thinner than the skin depth thereof, and/or at a thickness sufficiently small to have porous or discontinuous disposition. In other embodiments dielectric cladding is utilized where the cladding comprises a material having lower refractive index than a material forming a core of the CRTR. In some embodiments the core material comprises a fluid, and in other embodiments the cladding comprising a fluid.

Optionally, the process of forming the pits comprises the steps of patterning an etch mask on the stratum, and etching the pits in accordance with the etch mask. The etch is preferably an anisotropic patterned etch, and preferably is performed by a method selected from wet etch, plasma etch, reactive ion etch, “Lithography, Electroplating, and Molding” (Colloquially known as LIGA—Lithographie, Galvanoformung, Abformung), ion milling, and any combination thereof. In other embodiments the pit is formed by utilizing a focused ion beam (FIB), a direct laser etch such as Laser Photo Ablation and the like, or any combination thereof. While the above examples involve common technologies, the skilled in the art would recognize that any pit forming method capable of providing the desired pit dimensions and profile may be utilized.

In certain embodiments the methods of forming CRTR's within the pits comprises the step of placing a stamp tool having a plurality of protrusions extending therefrom, the protrusions are dimensioned at least in part as CRTR cores; aligning the stamp tool with the pits, and inserting the stamp tool into the pits for defining the CRTR's cores. In certain embodiments the method comprises applying a dielectric material to the stamp tool prior to the step of inserting. In certain embodiments the dielectric material forms the cladding. Optionally a layer of thin or perforated conductor, or lower index of refraction dielectric material from the dielectric layer is applied to the stamp tool prior to the step of applying the dielectric material.

Optionally the method further comprises a step of disposing dielectric material into the CRTR pits prior to inserting stamp tool. Alternatively, the method further comprises the steps of providing a fluid which is solidified about the stamp protrusions. In certain embodiments the method further comprises removing the stamp tool and disposing CRTR core material within the space previously occupied by the protrusions. In some embodiments the fluid may not require the step of solidifying and may be left in fluid state, especially if a seal is formed between the stratum and the stamp tool, and/or is the operating environment is submerged in such fluid, as for example in the case of gas cladding.

Optionally the stamp tool comprises transparent matter. Further optionally, the step of solidifying occurs by providing radiant to the cladding material via the stamp tool. In some embodiments the stamp tool is left as a portion of the CRTR based device, such that the protrusions form the CRTR cores. Therefore, such method for making a CRTR based device comprises providing a stratum having pits formed therein, providing a transparent stamp tool having a first surface having protrusions extending therefrom, the protrusions dimensioned at least in part as CRTR cores; aligning the stamp tool protrusions with the pits, inserting the stamp tool into the pits for defining the CRTR's cores. By leaving the stamp tool in place, affixing it to the stratum and/or surrounding structure, the stamp tool forms a portion of the CRTR based device. Optionally as described above, the method may further comprise disposing a fluid cladding material between the stamp tool and the stratum. In other embodiments the method may comprise the step of depositing cladding between the stamp tool and the stratum by any desired method, including by way of example depositing the cladding on the stamp tool prior to the step of inserting. The stamp tool or a portion thereof, may be formed to act as a lens and/or a protecting layer over the CRTR's.

In certain embodiments at least one lens is formed on top of the CRTR core. In other embodiments, a collimator is formed on top of the CRTR core.

In some embodiment the stratum comprises a buffer layer. In some embodiments the method further comprises the step of laying a first electrode proximal to at least one CRTR core, depositing a collimation layer above the first electrode, depositing a second electrode above the collimation layer, forming at least one hole in the collimation layer such that the hole would at least partially coincide with the core of at least one CRTR, and depositing an electrically activated radiant energy modulator on the walls forming the hole. Optionally the stratum comprises a collimation layer having variable collimation layer. A variable collimation is thus also provided, having a block of base material having a plurality of substantially parallel holes formed therein, the holes having walls, wherein the walls are at least partially covered with a radiant energy modulators, and electrodes disposed to control the radiant energy modulator, such that the radiant energy modulators vary the radiant energy conduction of the modulator, for allowing radiant energy to be controllably absorbed in or reflected from the base material. By modulating its absorption of reflectance, the radiant energy modulator may change the effective length of the collimator. The base material may be reflective or absorptive of radiant energy. The modulators may be a semiconductor, a ferroelectric material, or a liquid crystal which changes its optical state in response to an electric field or magnetic. A plurality of electrodes may be provided for controlling the modulator. The modulator may also comprise a piezoelectric or ferroelectric material for electrically adjusting the effective length of the collimator. Memory metal may also be utilized to vary the mechanical properties of the modulators.

In certain application it is desired to form a lens over a plurality of CRTR's. In certain applications a lens is formed over a base surface defined by the apertures of a plurality of CRTRs, and having a dimension defined by the extents of the CRTR's to be served by the lens. Optionally the base surface is disposed at or about the focal plane of the lens, which means that light collected by the lens passes its focal point and diverges to cover the base surface. The lens may be formed of a plurality of materials. In other embodiments a concentrator such as a mirror arrangement may be utilized.

There are also provided methods for patterning a stratum having a light and/or electrostatic charge sensitive etch mask disposed thereupon. In one embodiment the method comprises exposing the etch mask utilizing a plurality of laser print heads. In other embodiments the method comprises exposing the etch mask utilizing a plurality of CRTRs. Other embodiments comprise applying an optical template tool to the etch mask, and providing light and/or electrostatic charge therethrough. In some embodiments the optical stamp tool is in the form of a template roller.

The invention comprises a plurality of other features and aspects as described within these specification.

### BRIEF DESCRIPTION OF THE DRAWINGS

The summary, above, and the following detailed description will be better understood in view of the enclosed drawings which depict details of preferred embodiments. It should however be noted that the invention is not limited to the precise arrangement shown in the drawings and that the drawings are provided merely as examples.

FIG. 1 depicts a simplified diagram of a CRTR, showing simplified wave propagation therein.

FIG. 2 (a-e) depicts stages in construction of a layered stratum. FIG. 2F depicts certain flow steps embodying the process of FIG. 2.

FIGS. 3 and 3E depict structure and manufacturing process of yet another embodiment, showing a non-layered stratum formed in place about the CRTR cores.

FIGS. 4 and 4A depicts a class of devices, where a wafer or other substrate 101 comprises a plurality of transducers 102, where a wafer or other substrate comprises a plurality of transducers, and a transparent slab type stratum is disposed therebove.

FIG. 5 depicts a similar construction and method to that of FIG. 4, but in such embodiments, the CRTR's are formed within a layered stratum, and the transducers are disposed within the layers, rather than in a slab type stratum.

FIGS. 6A, 6B, 6C, and 6D depict process steps and two stages in a process of creating a CRTR utilizing a stamp tool.

FIG. 7 depicts an embodiment wherein the stamp tool of FIG. 6 is permanently left in the CRTR based device.

FIGS. 8 and 8A depict a method and process steps for making stratum and CRTRs, optionally in pixel configurations, using lamination. FIG. 8C depicts an optional continuous deposition process for manufacturing a stratum.

FIG. 9 depicts a schematic cross-section of an edge connector for lateral waveguides, and FIG. 9b depicts a simplified method for making stratum compatible with such edge connector.

FIG. 10A through 10F depict simplified diagrams of optional patterning methods and equipment thereto, especially beneficial for roll-to-roll manufacturing.

FIG. 11 depicts a laser based method of manufacturing.

FIG. 12 depicts a method wherein a CRTR pit is formed by successively etching a metal layer and then a waveguide core repeatedly.

FIG. 13 depicts a waveguide layer produced using self-assembled monolayer methods.

FIG. 14 depicts a block co-polymers comprising repeats of both acceptor and donor material with flexible hinging polymer sections.

FIG. 15 depicts yet another embodiment of the invention utilizing growth for creating the stratum and a stamp tool for creating CRTR based devices.

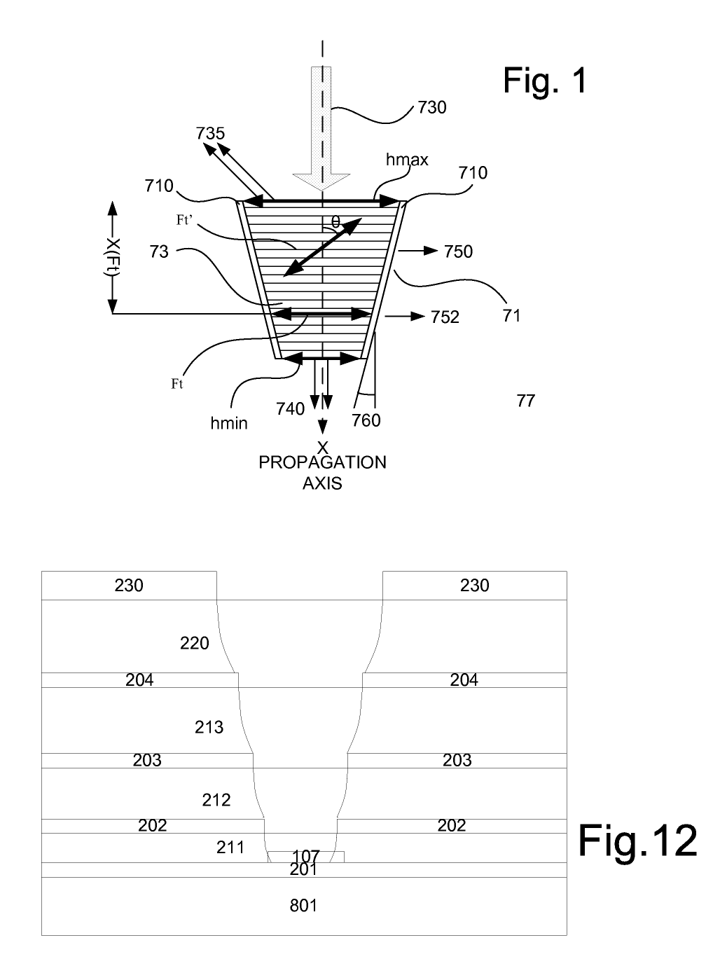

### DETAILED DESCRIPTION

CRTR core materials may vary widely, and material selection is an engineering choice. If the cladding comprises conductive material, the dielectric constant of the core material is arbitrary. Air, inert gas, or a cooling liquid of controlled dielectric constant and sufficiently low optical absorbance are all considered. By way of example, perfluoropolyether and fluoroalkane liquids have very reproducible properties, excellent optical transparency, low viscosity and good wetting to hydrophobic metals. Mixtures of related fluids may be used to tune the dielectric constant in operation. These materials have excellent heat transfer properties and could be used to remove excess heat by flowing in the z-direction along defined ridges if the etched regions form long slots.

Both low-k and high-k solid dielectrics are also suitable as core material in metal clad CRTR's; however, if a dielectric clad system is utilized, the cladding material has a lower dielectric constant (lower index of refraction) than the tapered waveguide core. This favors low-k solids such as aluminum oxide, silicon dioxide, or polymers for the cladding and high-k transparent materials such as TiO₂ or Si₃N₄, for the core. Water and other aqueous liquids allow the same fluid cooled system while using an alcohol/water or other suitable mixture to continuously adjust the dielectric constant of the core. Hafnium oxide, a well-known high-k material from the semiconductor industry is also suitable as core material.

Depositing layered material to form layered substrate is well known in the art, and techniques used in the semiconductor and other industries for such deposition technologies will be clear to the skilled in the art. By way of non-limiting examples, such deposition methods may include evaporation, sputtering, sublimation, and the like. Roll-to-roll manufacturing technology utilizing deposition is also well known in the art. In their article in the EE Times (c) dated Jul. 10, 2012 and titled “Roll-to-roll manufacturing for small molecule flexible OLED devices”, S. Mogck, C. Lehmann, T. Wahski, C. Rahnfeld and C. May describe several web deposition method and the skilled in the art would recognize additional applicable technologies. Combinations of material families to be deposited are dictated by the device to be manufactured, and are generally a matter of technical choice and design. While several examples are disclosed herein, these examples should not be construed as limiting the disclosed processes and structures.

While forming pits in materials are known, the profile of many CRTR's presents some difficulties using common etching techniques. The CRTR tend to be a narrow and relatively deep hole, and several manufacturing methods call for the pit to be precisely tapered, and preferably smooth. Thus several techniques are disclosed herein to ease the production of such structures.

The structure of the stratum is a matter of technical choice, decided upon by the application at hand, and the constraints attached thereto. In certain applications, most or all of each layer will be active. In other embodiments only sections of the layers are active, and thus, by way of one example, the stratum layers will comprise mostly inert material, with transducers such as light sources, light modulators, specific sensors, lasers, and the like, disposed at different locations in the layer. In certain embodiments filler layers may be disposed between active layers, or as a portion thereof. The composition of the various layers and devices within the strata would be dictated by the application, intended use, and by other technical choices.

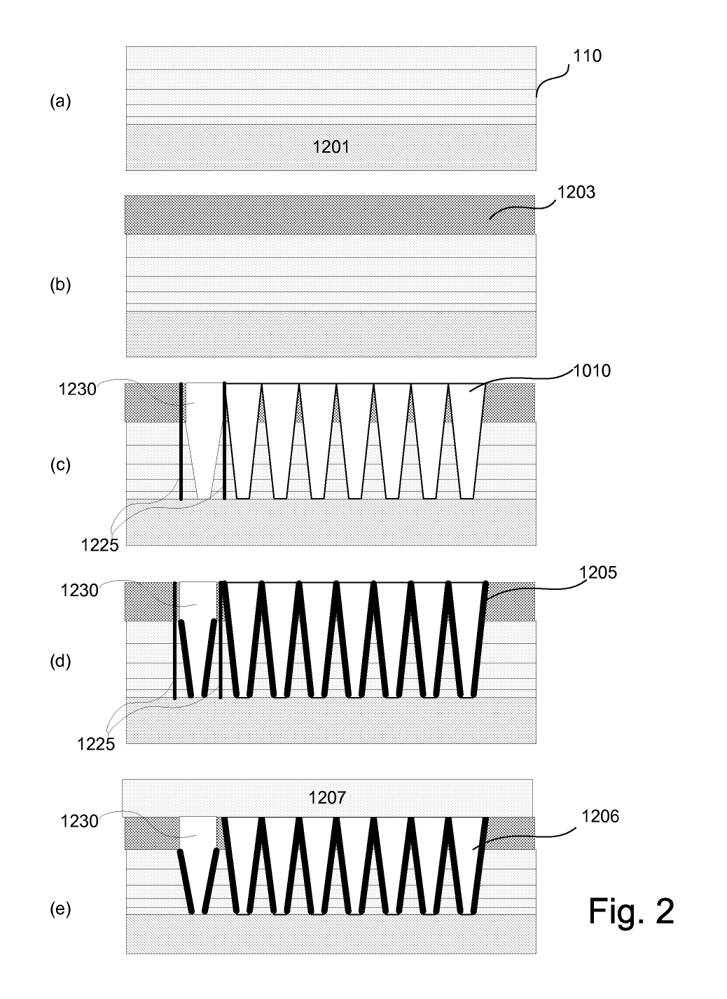

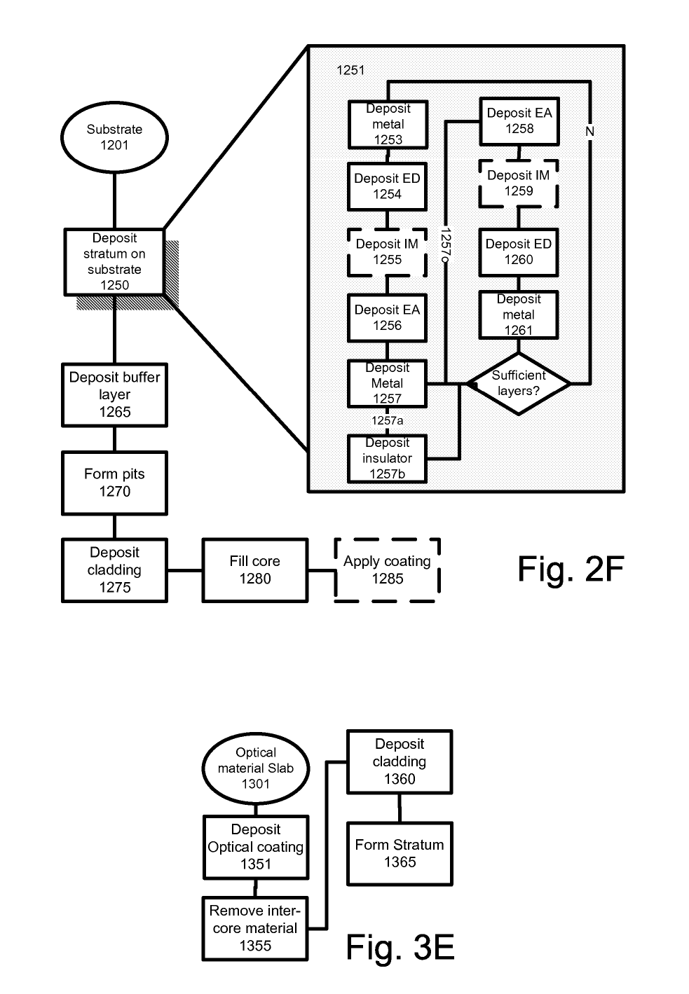

FIG. 2 depicts a simplified diagram of one optional manufacturing method for continuous resonant trap refractors suspended in a layered stratum. Beginning with a suitable substrate 1201, a stratum 110 is disposed in step 1250 on the substrate, (FIG. 2F) to receive spectral components of radiant energy refracted from the CRTR's, or to couple spectral components of radiant energy thereto. In this example, the stratum comprises lateral waveguides, but as described elsewhere, it may be in the form of a slab stratum.

A simplified flow diagram of the process of creating a layered stratum having EL and/or LE structures, comprising donor and acceptor layers which is depicted in box 1251, where layers are deposited. First, a metal is deposited 1253 on the substrate 1201, then an electron donor material is deposited 1254. Optionally a layer of intrinsic material is also deposited 1255. Layers of electron acceptor and a second metal layer (which may optionally differ from the metal of step 1253) are further deposited in steps 1256, 1257 respectively. The process may then be repeated until sufficient number of layers are deposited. Optionally path 1257a is followed to deposit insulator layer 1257b. In another embodiment, the layered stratum is constructed such that electron donor layers are deposited in back to back relationship to each other, separated by at least a metal layer. In such cases path 1257c is followed, and another electron acceptor layer is deposited 1258 on the metal layer of step 1257, followed optionally be intrinsic material 1259, by electron donor 1260, and by another metal layer 1261. As before, if the desired number of layers have been reached, the creation of the stratum is then complete, and if more layers are desired, the process is repeated. With each layer baffles 1225 or portions thereof may be deposited between individual sections of the stratum. Commonly, the baffles will form an energy barrier either by being reflective or absorptive. In certain embodiments the baffles will be electrically conductive and optionally form electrical interconnect vias. Baffles are preferably deposited as part of the deposition process 1250.

FIG. 2 optionally calls for a buffer layer 1203, which may then be disposed 1265 upon stratum 110 (FIG. 2b), if desired.

Pits 1010 (FIG. 2c) are formed 1270 in the stratum. Optionally, a two-step process forming plural slopping grades may be utilized. In certain applications, a collimator may be desired, to collimate energy coming into a CRTR, and thus the tapered core may require a substantially vertical pit disposed thereabove, such as depicted in FIG. 2 by optional collimator 1230. In other embodiments, a shallower slope may be required to direct radiant energy into the CRTR by forming wider waveguide or light-pipe (not shown). Such features as light-pipes, waveguides, and collimators placed on top of the CRTR aperture, or in continuation of the CRTR tip, are common to many applications and their creation, when required may require additional layers and additional or modified etching steps. The steps required for creation of such structures will be clear to the skilled in the art in light of the teaching provided herein in combinations with the common state of the art.

Cladding material 1205 is applied 1275 using any applicable deposition methods such as ALD, evaporation, sputtering, CVD and the like (FIG. 2d). Finally, the pits are filled 1280 with the core material 1206. If desired an optional protective, sealing, and/or antireflective coating 1207 is applied (FIG. 2e). Collimator pits such as 1230 may be continued through the protective coating, if desired.

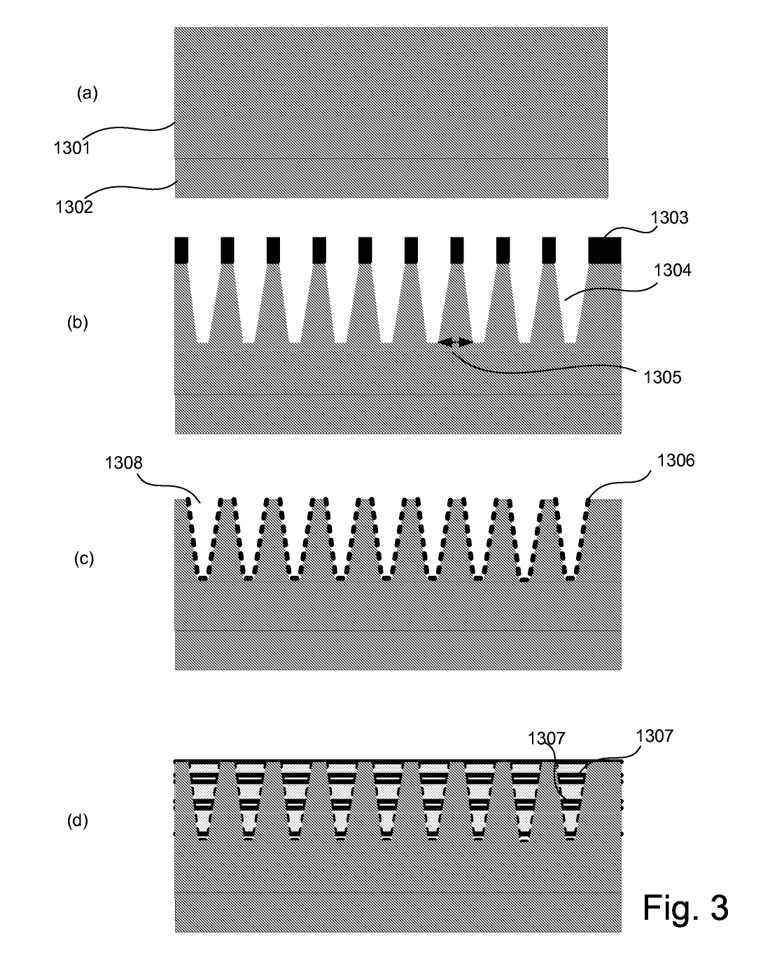

FIGS. 3 (a-d) and FIG. 3E depict Back Side Construction (BSC) manufacturing method. A slab of radiant energy transmissive or optical material 1301 is provided. The CRTR cores will be formed of the optical material 1301, and are defined by etching portions of the optical material. The optical material is optionally first coated 1351 on one face with optical coatings 1302, such as antireflective and/or protective layers (FIG. 3a). An etch mask 1303 is then defined on the opposite face of the stratum and the inter-core material region 1304 between the desired CRTR cores is removed (FIG. 3b) in step 1355. The masking dimensions define the bottoms of the tapered waveguides, and therefore the maximum frequency which will be refracted by the CRTR. The etch profile determines the optical aperture 1305 and therefore the minimum frequency which can enter the CRTR.

Cladding layers (dashed dark lines) 1306 are then deposited (FIG. 3c) in step 1360, and a stratum is formed 1365 in spaces 1308. The stratum may comprise a single optical material, or may be formed as layers forming a plurality of transducers 1307 (FIG. 3d).

It is noted that in this embodiment the stratum is formed after the CRTR cores and the cladding are already formed.

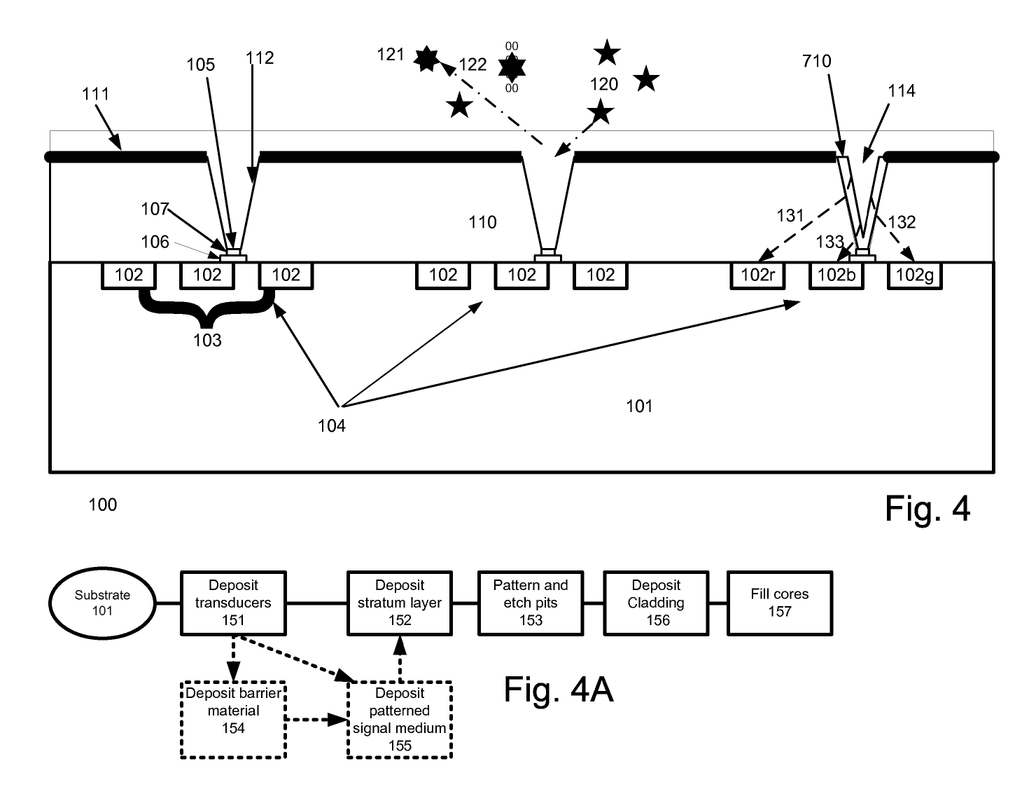

Additional layers and or components, including converters, transducers, active and/or passive electronic components, and wiring, may be disposed over optical material 1301. In an optional embodiment, the region 1304 may be filled with an optical material after the cladding is deposited, or the cladding material comprising an optical material with differing refractive index. The cladding and/or optical material then become a slab type stratum or a portion thereof. A plurality of transducers and optionally wiring, circuitry, and the like is then disposed to receive spatially separated spectral components via the now filled region 1304, to form a device akin to the device shown in FIG. 4, however utilizing a different form of manufacturing.

FIG. 4 depicts a class of devices, where a wafer or other substrate 101 comprises a plurality of transducers 102. Optionally individual transducers are arranged in sub-arrays 103 and sub-arrays are arranged in arrays 104. One or more devices may be fabricated on the wafer or substrate. By way of non-limiting example, such a wafer could comprise a silicon-on-sapphire (SOS), other silicon-on-insulator (SOI), other epitaxial semiconductor wafer, or single crystal semiconductor wafer. Signal amplifiers, encoding circuitry, and signal processing circuitry and the like may also be disposed on or in the substrate. Alternatively, the circuitry may reside in the stratum (not shown).

Therefore, as shown in FIG. 4A, beginning with the substrate 101, transducers are deposited 151, as well as any other optional circuitry. A stratum 110 transmissive of the radiant energy in the spectrum of interest is deposited 152 upon the substrate 101. The pits are patterned and etched 153. Stratum 110 is covered with patterned barrier material 111. The patterned material acts as a barrier to an etchant that is a suitable removal agent of the stratum material.

Etchant 120 (depicted as 5-pointed star) is then used to selectively remove the exposed stratum media, forming pits.

In some optional embodiments, substrate 101 is patterned 155 with a signal medium 105 at or near the CRTR tip to which CRTR pit will be etched. As seen in FIG. 4A, if taken this optional step takes place prior to the deposition 152 of the stratum layer. The signal medium is utilized to indicate the etch depth, such that when the etch reaches this medium, traces of the resulting signal medium byproduct 121 (depicted as 7 pointed star) are detected in the process effluent 122, along with unused etch and stratum byproduct (depicted as 6-pointed star), signaling completion of the etch process. Depending on the desired cross-section of the tip of the CRTR, the etch process could be stopped at the first detection of byproduct, at the exhaustion of byproduct, or at any desired time which may be calculated or experimentally determined, to provide the desired pit profile.

Optionally, an etch barrier material 106 is patterned and/or deposited 154 on the substrate 101, and the etch signal material 105 is optionally deposited on the etch barrier material 106. In some embodiments the etch signal material does not cover all of the etch barrier material. In such embodiments, the exhaustion of etch signal material byproduct in the effluent indicates that the tip has been etched to the barrier material while the larger extent barrier material continues to protect the underlying substrate or other structure.

Optionally, the remaining signal material 105 or the etch barrier material 106 can be selected to be reflective to radiant energy of frequencies beyond the highest frequency in the spectral range of interest of the CRTR. Doing so provides an optional feature of the CRTR, wherein such radiation is reflected back outside of the CRTR structure, reducing UV damage and heating by way of example. Other combinations will be clear to the skilled in the art, such as a combination which calls for protecting the substrate 101 with etch barrier material 106, but without utilizing an etch signal material, and the like.

The etchant is cleaned away and cladding material 710 is deposited 156. Finally a core material 114 is used to fill the CRTR and optionally coat over the entire structure. Optional protective and anti-reflective layers are not shown.

With properly dimensioned CRTR, there will exist a cladding penetration depth in the core and a corresponding emission depth and angle from the cladding for each frequency of interest. For the example depicted in FIG. 4 the spectral range of interest is the visual range. Rays are drawn for red light 131 reaching transducer 102r, green light 132 reaching transducer 102g, and blue light reaching transducer 102b. A symmetrical conical taper of the CRTR core of the core would result in a conical beam of emitted light at each wavelength.

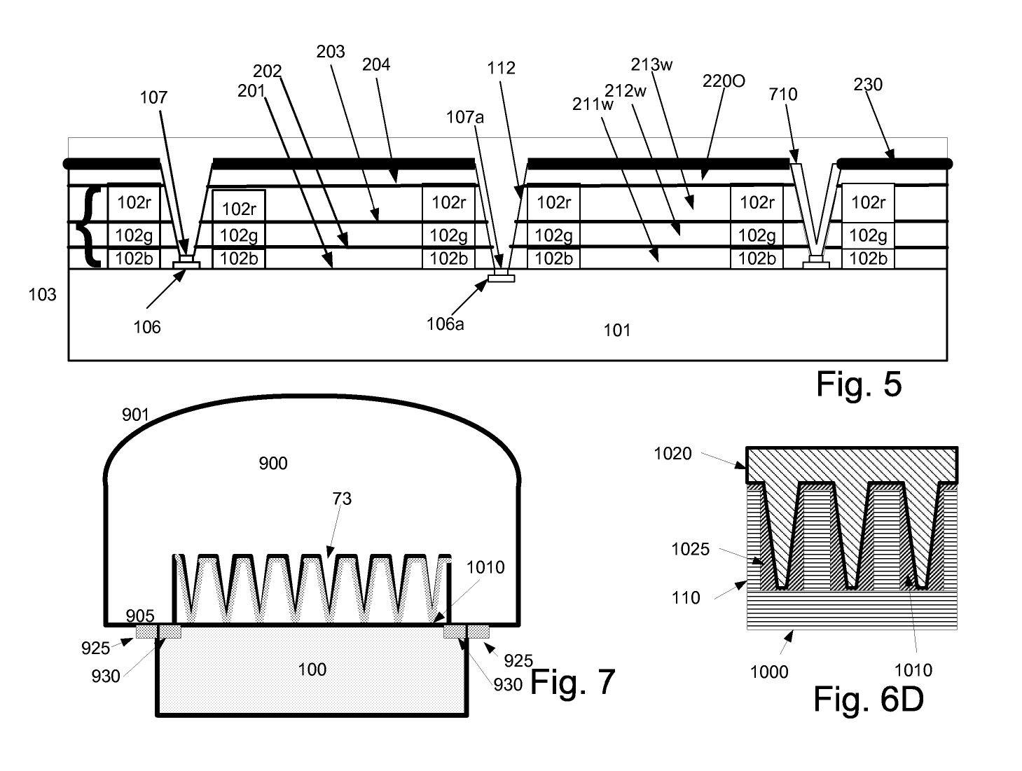

FIG. 5 depicts a similar construction and method to that of FIG. 4, but in embodiments like the one depicted in FIG. 5, the CRTR's are formed within a layered stratum, rather than in a slab type stratum depicted in FIG. 4. This figure depicts more clearly how substrate 101 supports the stratum composed of metal layers 201, 202, 203, and 204 as well as waveguide layers 211W, 212W, and 213W and optional overlayer 220O, all deposited prior to patterned etch barrier 230, and forming lateral waveguides. The waveguide layers are further shown with transducers 102r, g, and b deposited in waveguides. In certain applications such as energy harvesting applications, the transducers extend between the CRTR's. In applications requiring division into sections, such a pixel based applications, individual transducers are deposited adjacent to their respective CRTR's, or in communication therewith.

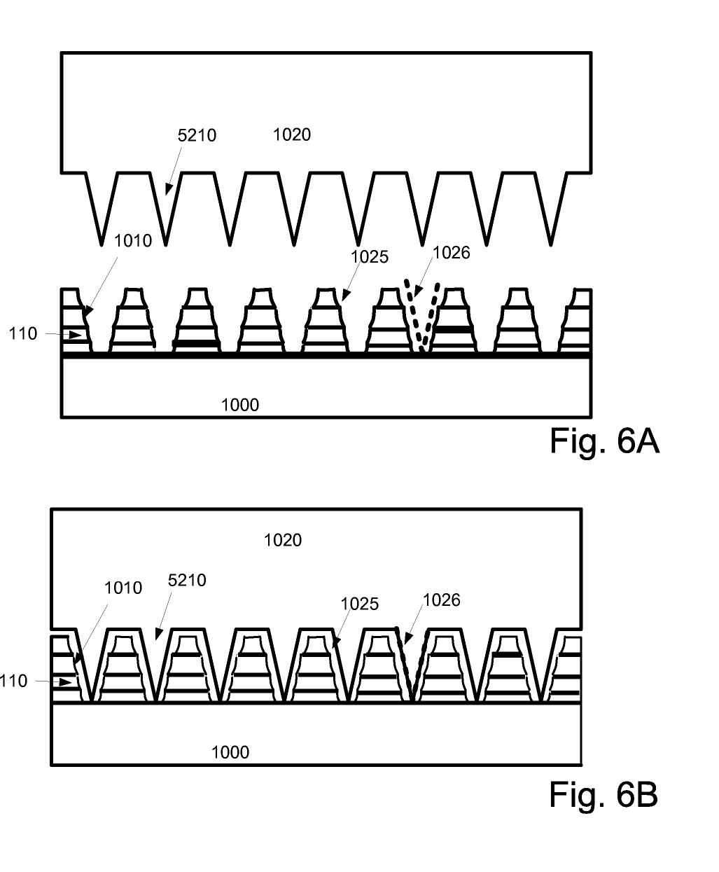

FIGS. 6a, 6b, and 6c depict an alternate embodiment which accommodates relatively imprecise etching of the CRTR outer dimensions which is done by any desired method. A stratum 1012 is deposited 1050 over wafer 1000 and is etched to form pits 1010 defining the CRTR outer shapes. Optionally other layers such as protective cap layer, buffer layers, and the like, are also deposited

A stamp 1020 having protrusions 5210 corresponding to the CRTR cores is provided for insertion into the CRTR pits, as shown in FIG. 6b. By way of example, such stamp could be formed using methods similar to those used to make the optical core material of FIG. 4. The term pits in this context are the voids in the stratum into which the CRTR's are created or placed, including the cladding and the cores.

In one optional embodiment, the pits are filled 1054 with a filler dielectric material 1025, and the stamp is aligned and inserted 1058. The dielectric material is displaced into the desired shape by the insertion of the stamp, and becomes the cladding 710 of the CRTR.

In other embodiments the stamp protrusions 5210 are first covered 1056 with the dielectric material 1025. The stamp is then inserted 1058 into the pits 1010, as described above. The dielectric material may comprise a UV curable material, a thermoset polymer, a self-curing polymer, a glass, a dielectric fluid, and the like. In some embodiments, the dielectric material 1025 itself forms the cladding, while in other embodiments it acts only as an intermediate medium, or a portion of the cladding.

In some embodiments, the stamp is first coated 1057 with a thin or perforated conductor or low index of refraction dielectric material 1026 which will serve as the cladding. This coating step occurs prior to the covering step 1056. Preferably, the Material 1026 has poor adhesion to the stamp 1020 and good adhesion to stratum material or an intermediate material. In such embodiments the dielectric material 1025 serves as an insulator between conducting cladding and the conductors between waveguide layers of the stratum.

In some embodiments the stamp is inserted 1058 into the pits in registration as described for other embodiments, and cladding material is flowed 1060 into the spaces between the pits outer shape and the stamp. The cladding material may then be cured in place if desired.

Optionally, the cladding material comprises a powder and the process is performed at a temperature in which the powder flows about the stamp. Alternatively, the stamp is heated to melt the powder.

In some embodiments, the stamp is withdrawn 1062 after forming the dielectric material 1025, and/or the cladding. If cladding has not been deposited (such as in steps 1057, 1054, or 1060), cladding is then deposited 1064 on top of the dielectric material 1025 by any desired method, such as atomic layer deposition, and the like. Such cladding may be thin or perforated conductive or low index of refraction dielectric layer 1026. Alternatively electrochemical methods or chemical methods form thin or perforated conductive or low index of refraction dielectric layer 1026. The CRTR's are then filled 1066 with the core material.

In some embodiments fluid is utilized as the core material, and a cap is deposited on top of the CRTR's to retain the fluid. The core may be formed of air, or the core may be any appropriate solid material which may be deposited by any desired method.

In the embodiments depicted in FIGS. 6 and 6a, and in several other embodiments, dielectric material 1025 planarizes the imprecise formation of the etched CRTR outer shapes 1010 and adheres a thin cladding transfer layer to the exposed face of the CRTR. In certain embodiments core material is filled in, and in certain metal cladding embodiments, those methods may be utilized to form a metal clad and air core CRTR.

In some embodiments the stamp tool, or a portion thereof, is made of material transmissive of the spectral range of interest, and the stamp tool is left permanently embedded in the structure, and forms at least the CRTR core, at which case the process is complete. The stamp 1020 may also be formed to any desired shape to accommodate the intended use of the device. Thus the stamp may form structure such as a protective layer, anti-reflective layer, collimation layer having collimators place on top of the CRTR's apertures, concentrators, mirrors, lenses, and the like apertures, where the stamp tool is to become a permanent or at least semi-permanent portion of the manufactured device, At least the protrusions, and oftentimes the majority or whole stamp tool, is transmissive of radiant energy in the spectral range of interest.

An alternative method of creating CRTR pits allows for creating vertical, rather than tapered pits, and deposition of cladding material to form the desired taper. A simplified example is depicted in FIG. 6D where the use of a stamp 1020 allow a vertical pits 1010 to be filled with dielectric material 1025 which will form the cladding or a portion thereof, and the stamp 1020 forms the CRTR cores, while displacing the cladding material to the desired taper profile. The stamp may be withdrawn after the cladding materials solidified, or it may be left in, as described above.

This construction allows for a wide variety of techniques and materials for depositing 1064 the cladding materials. In addition to the methods described above, in some embodiments a fluid is used as the cladding, and the stamp both serves as the core and acts as a seal. In embodiments where the cladding is UV curable, the UV energy may be applied via the stamp. If the stamp in such embodiments includes the CRTR cores, no further application is required. Dies and jigs may be used to facilitate the alignment process.

In one particular embodiment, the stamp comprises a lens, or is formed as a lens after production of the CRTR's. Such lens would serve to capture light and other radiant energy and bring it to focus at plane of the CRTR apertures. By way of example, FIG. 7 depicts an embodiment where the stamp is formed to act as a lens, with an outer surface 901, while having the CRTR cores 73 being formed on the opposite surface. The pits 1010 are formed on the wafer 100, the stamp is aligned and inserted into the CRTR pits 1010, and the space between the cores and the stratum is filled with the cladding material by one of the methods described above.

In some embodiments lens 900 has planarization surface 905 and electrical interconnects 925 connecting to electrical connections 930 on wafer or die 100. Optional encapsulant or package body (not shown) completes an electronic package for the device.

Core materials and cladding materials may comprise a plurality of materials as desired to change the refractive index or other wave propagation and guiding characteristics of the structure as a whole. By way of non-limiting example, the core material may comprise layers of material with varying energy propagation speeds, which may drastically alter the physical profile of the CRTR core, while maintaining the desired taper with respect to wave propagation therein.

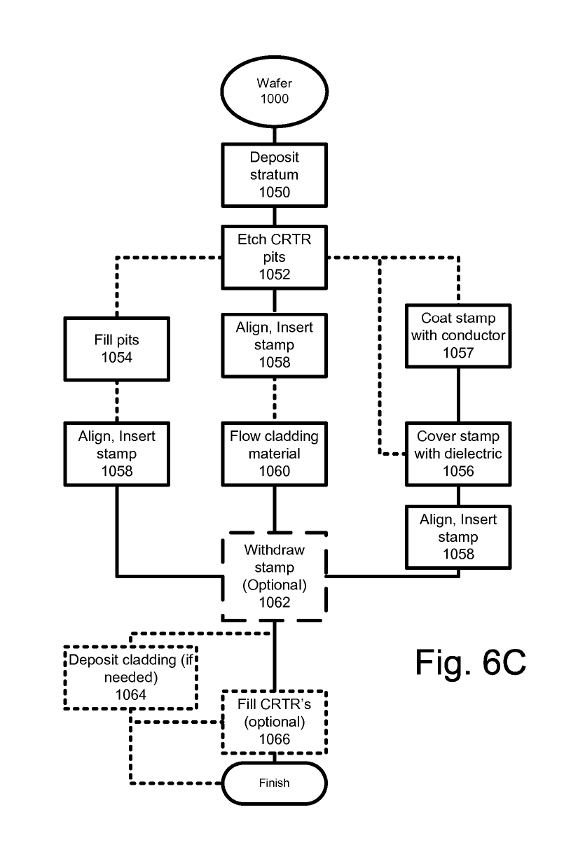

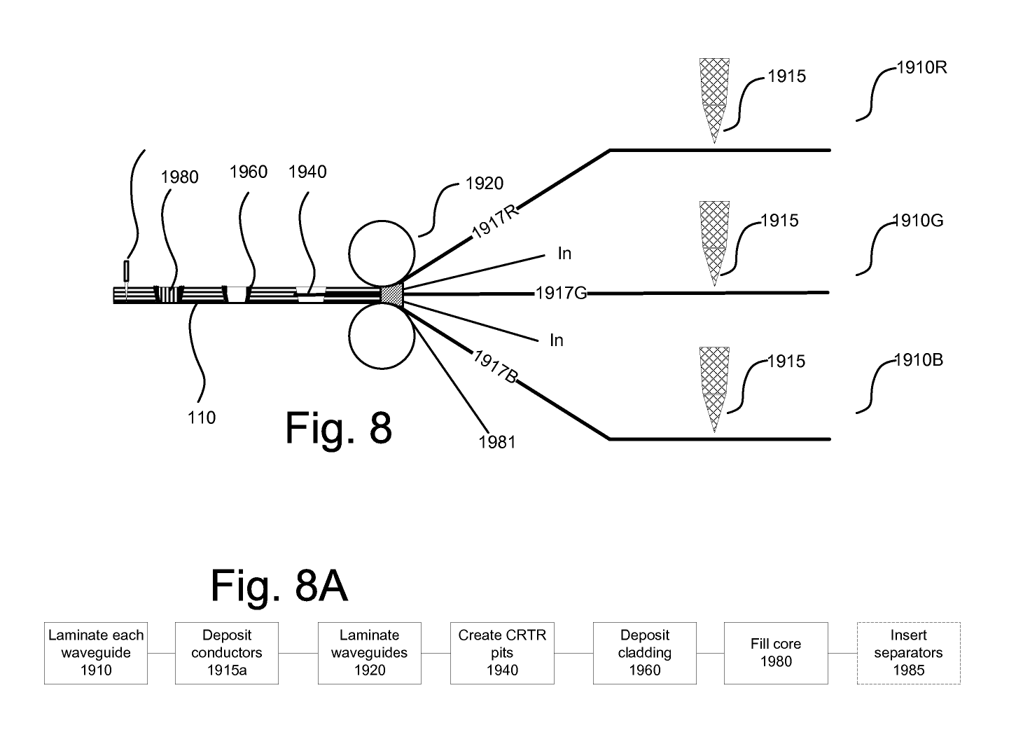

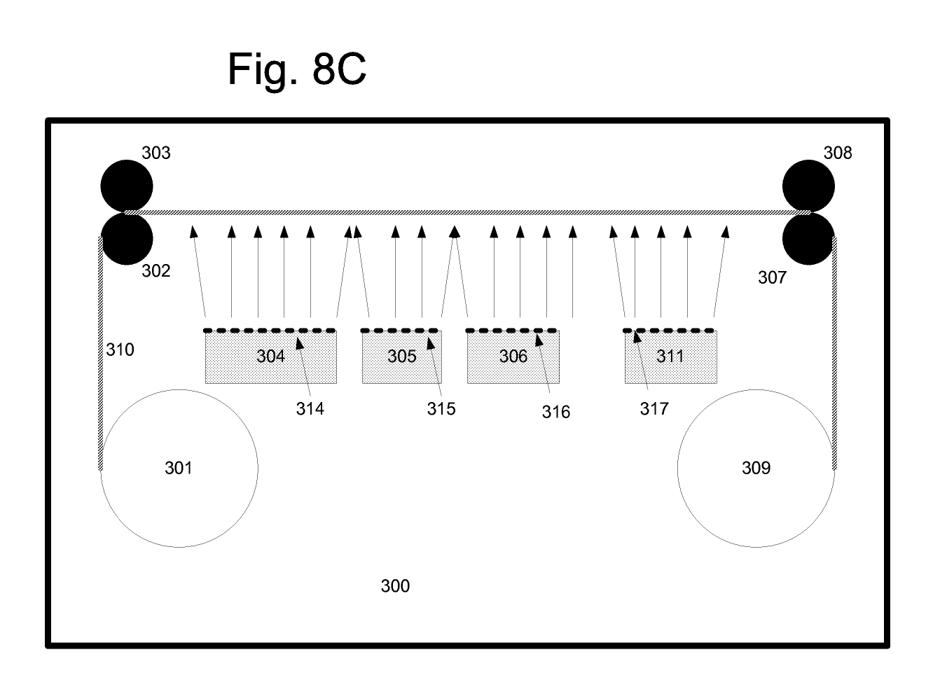

A simplified example of a method of manufacturing CRTR in layered structures is depicted in FIGS. 8 and 8a. This structure is especially suitable for sub-mm waves in which layer thicknesses and CRTR dimensions more easily allow laser drilling, flexographic printing, and laminated sheet stack-up methods, but the method may be utilized for higher frequencies as well.

An initial step of laminating a stratum 110 containing three lateral waveguide is shown and is readily extended to more or fewer spectral component bands. Firstly individual lateral waveguides 1910R, 1910G, and 1910B are formed 1910, each containing transducers. The transducers may be LE, EL or RL type, and may comprise continuous layers, or may be formed of individual ‘pixel’ transducers. Preferably, the lateral waveguides are optimized by dimension and/or transducer design, for their intended spectral component. If dictated by the application to which the stratum is directed, conductors 1915 are then added 1915a to the individual lateral waveguides 1917R, 1917G, and 1917B, to allow electrical coupling to individual transducer of individual pixels. Adding conductors only to one side is shown, but adding to both sides will be clear to the skilled person.

The individual lateral waveguides 191 OR, 1910G, and 1910B are then laminated together by laminating rollers 1920a optionally with insulating material In therebetween. An optional substrate layer is also added. Pits for CRTR's are etched, laser drilled, ion milled, or otherwise formed 1940, and the edges of the pits are coated with cladding material 1960. Core material is added 1980 into the pits, creating the functional CRTR. In optional step 1985, baffles are introduced into the transducer sheet, to separate the lateral waveguides into sections such as pixels. By way of example separators may be created by etching or milling into the sheet to a desired depth, and depositing metal or other wave blocking material, forcing a material grid, and the like. Alternatively the baffles are laid in during the layer deposition.

Such a lamination method might be particularly feasible for lower frequency imaging arrays wherein the layer thickness will approach those seen in polyimide flex circuits and antennas or rectennas may comprise plated through vias in laser drilled passages through the dielectric.

FIG. 8B depicts a simplified optional process for manufacturing embodiment using a continuous or substantially continuous evaporative, sublimation, or physical vapor deposition process, for manufacturing controlled thickness stratum. The process is described in its basic terms, as applied to manufacturing of solar cells, but the skilled in the art would readily understand how to expand it to better fit other products, such as displays, by way of example. Process chamber 300 provides a controlled atmosphere that might comprise clean air, inert gas, process gas, low vacuum, high vacuum, or ultra-high vacuum by way of non-limiting example. Source roll 301 feeds flexible substrate 310, optionally with a stratum being deposited thereupon through tensioning rollers 302, 303, 307, and 308, returning substrate to take-up roll 309.

The substrate in the present simplified example is assumed to have a first metal layer deposited thereupon, but the skilled in the art would readily recognize that such layer may be deposited using an additional deposition source (Not shown). The substrate moves at a controlled speed having controlled time duration of exposure to the deposition stream from sources 304, 305, 306 and 311. The amount of material deposited from each source depends on the deposition rate (r, measured in nm/sec.) for each material, the source length (L, measured in meters), and the velocity of substrate travel (v, measured in m/s). Thus if source 304 deposits an electron donor material, 305 deposits an intrinsic material, and source 306 deposits an electron acceptor material, the total thickness can be adjusted by controlling the velocity of the substrate while the relative proportions of P, intrinsic, and N-type material are determined by the individual source emission rates and lengths. The emission rates of the materials emitted by sources 304, 305 and 306 can be controlled by the degree of opening of apertures 314, 315, 316, and 317 respectively. Additional layers, such as the metal 311 and matching layers or transparent conductor filler layers, may also be deposited by adding additional sources and apertures provided the controlled atmosphere levels of the various sources are compatible. This process fits deposition methods such as evaporation, sputtering, sublimation, and the like, wherein atomized material from source 305, for example, has a low probability of colliding with another atomized particle and being deflected from the indicated line of sight path. Such methods are suitable to small molecule organic compounds, volatile organics, metals, oxides, nitrides, and the like. Methods of deposition may be mixed as required, and the skilled in the art would recognize that the process may be repeated several times, or that more deposition stations like sources 304, 305, 306, and 311 may be added for a single, continuous manufacturing process, or subtracted to fit other manufacturing limitations such as the process chamber size, deposition methods or material compatibility, cost, and the like.

The ability of laminating or deposition processes to control the thickness of each layer allows precise creation of lateral waveguides. Therefore by way of example, if a waveguide is designed to receive radiation in the 450-500 nm range, the desired waveguide aperture size would be slightly above 250 nm, compensated for propagation delay within the waveguide materials. Such dimensioning would slow the energy propagation speed of the radiant energy within the lateral waveguide, and increasing its effective length for conversion. However the skilled in the art would recognize that any desired thickness above the 250 nm may be utilized.

It is noted that in certain embodiments, different material combination may be utilized. Thus by way of non-limiting example, while the above mentioned example describes an electron donor/acceptor combination with intrinsic material therebetween, another example may comprise a first layer of transparent conductor, an electron donor/acceptor combination, and a second layer of transparent conductor layer. Such construction would increase the efficient conversion of incoming radiant energy to electricity, at the added cost of the transparent material and any ohmic losses it may present.

In certain embodiments, after the creation of the stratum is complete, the substrate with the stratum deposited thereon may receive an etch mask layer, the apertures patterned on the mask, and then the CRTR's formed within the stratum. Laying of the etch mask is well known, and various methods of patterning and/or forming the CRTR pits, depositing the cladding, and filling the CRTR cores, may be utilized. Improvements to common methods for achieving those tasks are disclosed elsewhere in these specifications. However the skilled in the art would recognize that those may be formed either in stages, where each roll-to-roll process creates one layer, a portion of the stratum, or that a longer line performing a plurality of deposition may be formed, for creating a complete stratum in a single roll-to-roll pass. However the skilled in the art would recognize that the stratum may be formed either in stages, where each roll-to-roll process creates one layer, a portion of the stratum, or that a longer line performing a plurality of deposition may be formed, for creating a complete stratum in a single roll-to-roll pass.

Preferably the materials comprising the waveguide would be relatively impervious to radiant energy of wavelength impinging on the waveguide, and more preferably, a transducer formed in the waveguide would have a bandgap optimized for the desired frequency range. In lateral waveguide constructions several waveguides are superposed above each other, preferably each being similarly optimized for frequency range it is intended to receive either in detector construction and/or in the lateral waveguide aperture and core dimensions.

It is noted that in certain embodiments, different transducer constructions may be utilized. Thus by way of non-limiting example, while some lateral waveguides may contain an electron donor/acceptor combination with intrinsic material therebetween, another waveguide may comprise a first layer of transparent conductor, an electron donor/acceptor combination, and a second layer of transparent conductor layer, and yet another lateral waveguide of the stack may comprise rectennas, quantum dots, and the like.

In most embodiments, after the creation of the stratum is complete, the substrate with the stratum deposited thereon may receive an etch mask layer, the apertures patterned on the mask, and then the CRTR's formed within the stratum. Laying of the etch mask is well known, and various methods of patterning and/or forming the CRTR pits, depositing the cladding, and filling the CRTR cores, may be utilized. Improvements to common methods for achieving those tasks are disclosed elsewhere in these specifications.

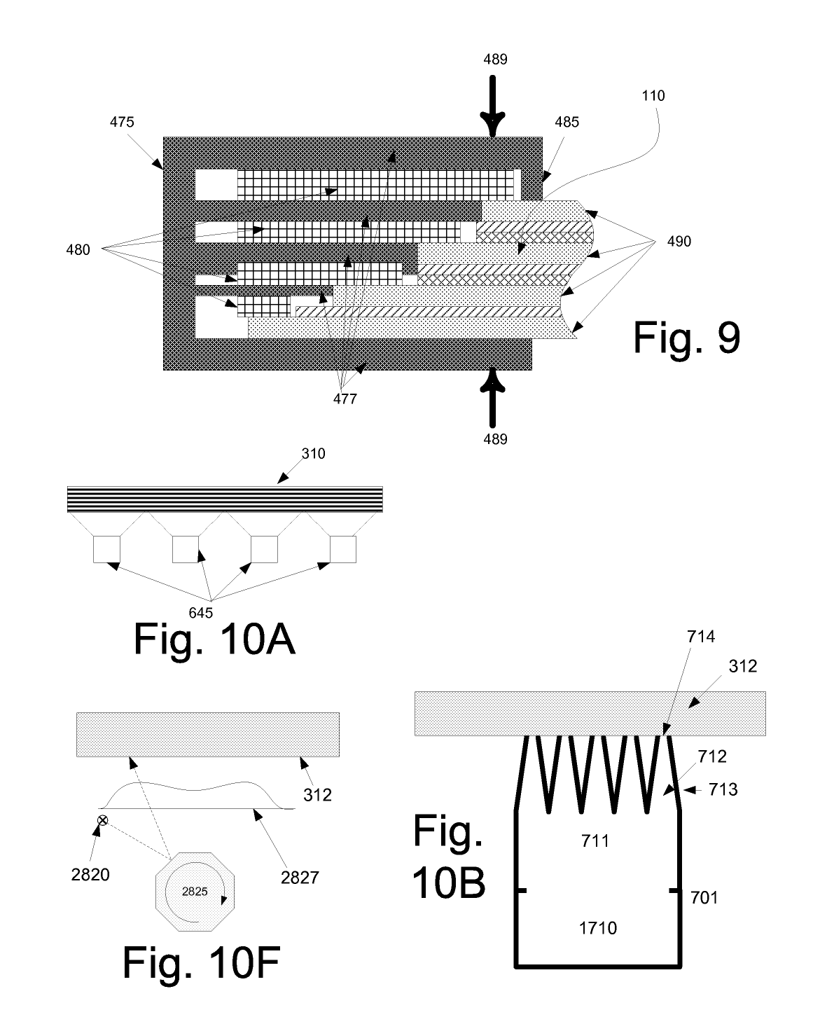

In certain applications, such as CRTR based panel type devices, it is desirable to provide electrical connections to conductive sheets within the stratum by an edge connector. FIG. 9, depicts a cutaway view of the edge portion of the panel device and connector. The layered stratum 110 comprises a plurality of layers with some layers 490 being electrical conductors. At a predetermined location along the edge of the stratum, the metal conductors 490 extend to the vicinity of the edge of the stratum, and are exposed at least on one side, to allow electrical contact. Edge connector 475 has a plurality of contracts 480 which provide electrical connection to conductor layers 490. Contacts 480 are preferably resilient, but any common connection method may be utilized. The contacts are disposed within the edge connector body 475. Insulating materials 477 and location aids are disposed as desired to assure positive contact, proper inter-contact insulation, and the like. The edge connector 475 may also provide sealing function to the connection, by any desired sealing method, depicted schematically as seal 485. The skilled in the art would recognize that various sealing methods may be deployed, at any desired location. The edge connector is urged against the stratum as shown by arrows 489. Optionally, the edge connector further encompasses a portion of the substrate, if a substrate exists. It is noted that the number of layers and contacts shown are merely to facilitate understanding of the construction and are any desired number of contacts and layers may be utilized. Furthermore, in some embodiments the conductor layers 490 may be staggeringly exposed along the stratum edge such that each conductor 490 is exposed separately along a portion of the edge (not shown).

When the stratum is perforated by a plurality of closely spaced CRTR's the conductive layers viewed in isolation would form a web with narrower paths in layers closer to the CRTR aperture, than in layers farther away therefrom. Therefore the layers closer to the aperture would tend to present progressively higher electrical resistance to current collection. This problem is of higher significance in high current applications, such as power harvesting or high powered transmission. To alleviate this problem, in some embodiments the conductive layers closer to the CRTR aperture are thicker than the metal layers further away from the CRTR aperture.

The feature widths required to create CRTR's in the visible and near IR range are typically in the order a few microns, to a few hundred nanometers. CRTR's with cutoff frequencies into the far IR and having low refractive index cores can have apertures approaching 10-20 μm while visible light systems with moderately high refractive index cores might have sub-micron apertures.

Certain aspects of the present invention are directed to provide improved methods of patterning masked surfaces for creating pits or other features which are required for creating CRTR's or for accommodating other aspects of the stratum. For most of those methods the stratum is coated with a etch mask material, which is then being patterned by exposure and subsequent processing which may comprise etch mask material removal or disablement, or conversely the exposed material becomes the etch mask, while unexposed regions are being removed and/disabled.

Common light projection printing steppers may be utilized for patterning devices of similar size to semiconductor manufacturing structures, of a few inches. Larger sizes ma be obtained by arranging one or more optical steppers to expose a pattern along the width of the sheet with the material being indexed forward one pattern size at the end of each scan. However such construct is time consuming and requires intermittent motion of the stratum film. It is preferable if the patterning can be carried out when the stratum is moved with a controlled direction and velocity.

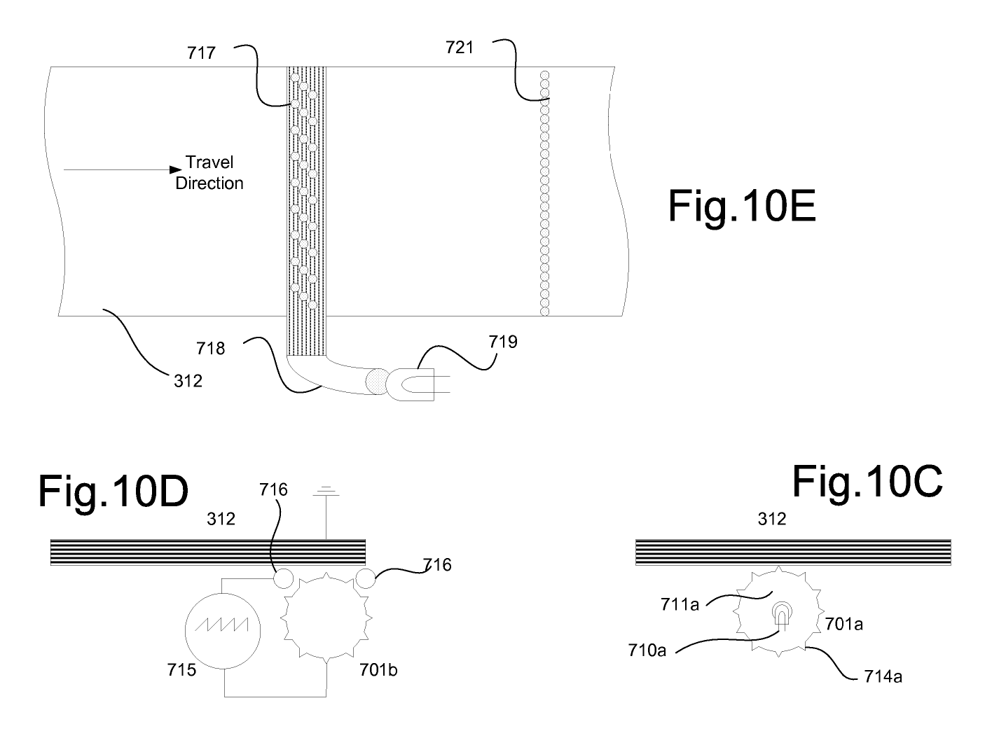

Direct-write optical imaging may be employed. FIG. 10A depicts one method where the patterning of step 621 is carried out utilizing a plurality of laser print heads 645 arranged so that their modulated output would form the desired patterns along the width of the substrate 310. Laser print heads 645 may be of any desired construction; heads utilizing rotating mirrors similar to those used in laser printers may be utilized. The principle of operation of the laser printer head is well known, and a simple illustration is provided by FIG. 10F. A laser source 2820 is directed at rotating multi-faceted mirror 2825, and the laser beam is modulated. The beam is reflected by the mirror as seen by the dashed line. A corrective lens 2827 provides the required correction to ensure that the laser beam would stay focused when impinging photoresist 312. The laser beams need to be sufficiently focused when meeting the etch mask material to form a feature of the desired accuracy. Calibration of the process to provide predictability as result of varying projection distances and the like may be required, and can be achieved empirically. If desired, the heads 645 may be staggered along the travel path of the stratum (not shown). This method allows relatively inexpensive construction which offers wide film patterning at high speed and high accuracy.

FIG. 10B depicts an embodiment directed at patterning a mask on a surface. An optical template tool 701 is brought into soft contact with the photoresist on the stratum and selectively exposes the photoresist to light in a precise pattern. The template tool 701 comprises UV light source 1710 coupled to transmission medium 711. The surface of transmission medium 711 opposite UV source 1710 comprises tapered pins 712. Tapered pins 712 are coated by reflective metal 713, and terminate in a tip 714, which is transmissive to the spectral component of the UV light source. The pin tips are brought into soft contact with the photoresist, and light from UV source 1710 is emitted from tip 714 to provide precise illumination onto the photoresist coating stratum 312. Tip 714 may be formed of any desired shape. The template tool may be formed to apply to large surfaces such as to cover the complete width of the stratum, or it may be moved from one location to another, to provide the desired coverage. The template tool may be formed with any desired CRTR patterns. It is noted that in some applications the template tool does not have to touch and proximity printing is also considered, as allowed by the required precision.

FIG. 10C depicts an optional variation of the process and system depicted in FIG. 10B, wherein the patterning step is performed by a template roller 701a which replaces the template tool 701. The construction of the template roller 701a is similar in principle to the template tool, as it comprises a UV light source 710a coupled to a transmission medium 711a which transmits the light from source 710a to UV transparent tips 714a. In an alternate embodiment, roller 701a is patterned with the desired pattern using nano-imprint lithography. The roller is utilized to transfer a precursor material in a liquid or soft solid state and then heat or light exposure is utilized to harden the barrier material to a hardened state prior to etching. This method is best suited to applications where precise alignment is not required, and it obviates the need for steps like photoresist developing, post-baking, and removal of barrier layer.

FIG. 10D depicts an optional variation of the patterning system depicted in FIG. 10C, where the mask material is sensitive to electrical or electrostatic charge. In this embodiment, roller 701a is replaced by a patterned roller 701b whose tips comprise a conductor. The roller is charged with static electricity by charge generator 715, and the charge is transferred to the stratum by proximity. Charge neutralization electrodes 716 are located in proximity to the charged tips, to control charge distribution.

FIG. 10E is a simplified diagram of yet another method for patterning an etch mask disposed on a moving stratum. In its most general form, those embodiments utilize arrays of light sources arranged in transverse direction to the travel direction of the stratum. A plurality of optical fibers 717 are bundled, and their ends are optically coupled to one or more light sources 719 which may be laser lights, UV lights, and the like. The opposite ends of the optical fibers are cut and arranged into rows which are then affixed across the travel direction of a traveling stratum, having a light sensitive etch mask disposed thereupon. In one exemplary construction, the bundle of optical fibers is joined and the bundle faces are polished. The optical fiber cores form the exposure points while the cladding and jacket of the fibers define the unexposed space between CRTR cores. If a closer spacing is desired, several rows of fiber ends are staggered relative to each other, and are optionally spaced apart in a direction parallel to the stratum travel direction. The staggering allows a very tight exposure pattern to be formed by synchronized pulsing of the light sources feeding each row, with the travel of the stratum. More complex patterns may be formed if different portions of each row are lit by separately controlled light sources. It is also possible to use a single light source to feed all the fiber rows by judicious spacing of the rows, such that the travel of the stratum would bring the pattern created by one row of fiber ends to the desired proximity relative the pattern to be formed by the next row. The light source is then pulsed in synchronization with the motion of the stratum. Thus, each of the fiber ends in the rows becomes a light point source, and together the rows form an optical template which is controlled by the common light source. In a similar arrangement individual light sources may be utilized. Further alternatively, the fiber rows may be replaced by rows of other light sources such as rows of LED's, and the like.

Another embodiment allowing large scale patterning of the stratum is to provide a row 721 of emitting CRTRs in soft contact with a traveling stratum. The CRTRs may be operated by a single light source transducer or individual light sources coupled thereto. Placing UV type lasers within lateral waveguides is especially advantageous for such embodiments, as they can handle high energy levels. If every individual CRTR has an individually controllable light source any desired pattern may be formed.

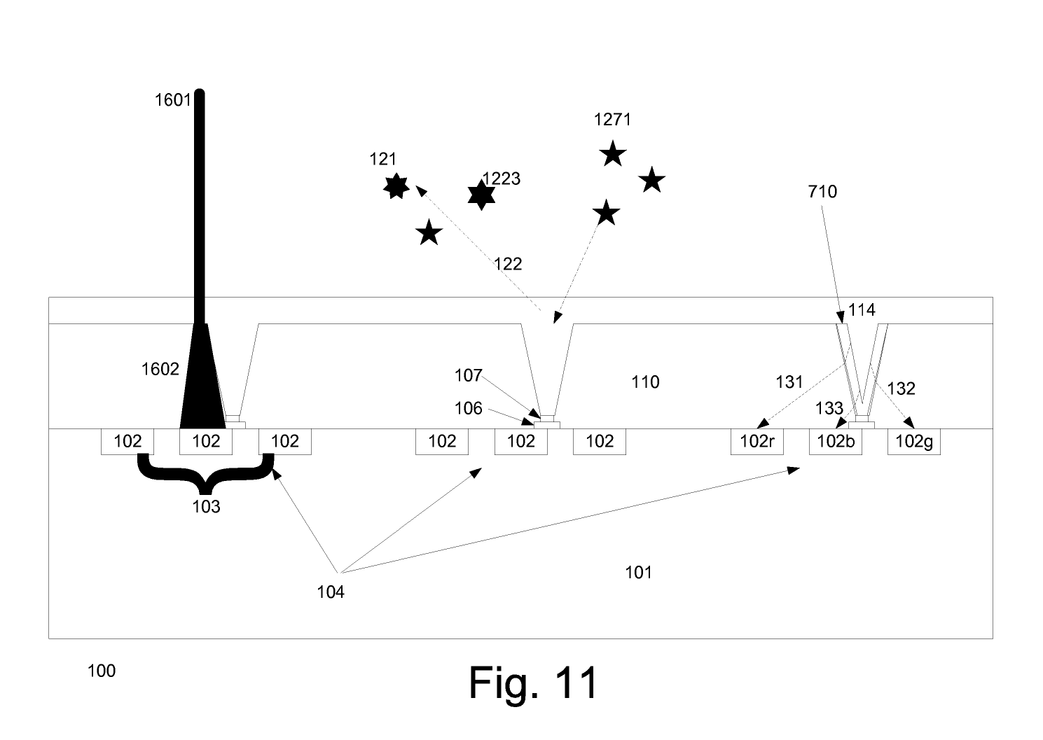

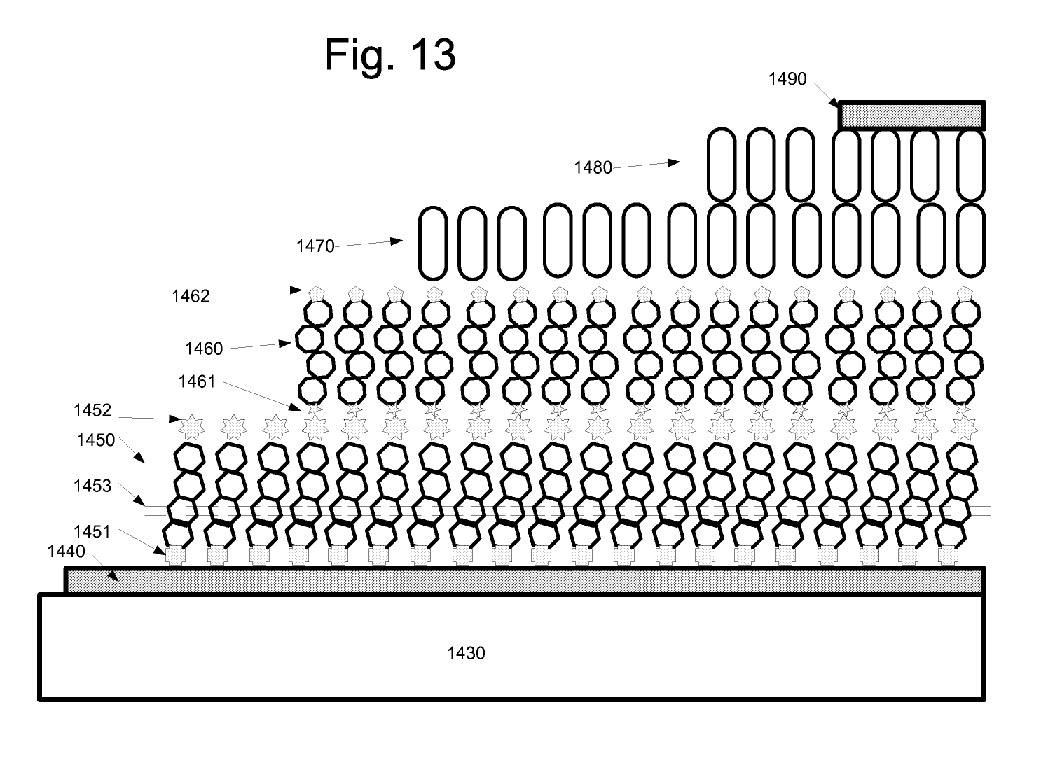

In yet another embodiment, depicted schematically in FIG. 11, optical material is provided as a low viscosity fluid such as UV cross-linkable monomers or oligomers. Laser patterning is employed to crosslink the monomers. Laser beam 1601 having sufficiently small spot diameter spreads within the fluid due to diffraction 1602 such that tracing the perimeter of a CRTR naturally results in a taper of cross-linked region. Process fluid 1271 dissolves unreacted monomers 1223 and optionally reacts with signal layer 107 to produce byproduct 121, as described in relation to FIG. 5. Yet another embodiment calls for utilizing three dimensional printing. While today's three dimensional printers do not have the required resolution required to create most CRTR's in the UV and shorter wavelength range, future developments are likely to enable such devices, and with them the matching manufacturing methods.

For certain applications, especially where it is already necessary to pattern and align multiple layers a process as detailed in FIG. 12 is suitable. In this process the stratum is created layer by layer with features that require patterning and forming of features such as individual transducers per CRTR, connecting vias, baffles, and the like, in each layer. As each layer is already patterned, each layer, or only some layer like metal layers 201, 202, 203, and 204, may be individually patterned and etched with properly sized CRTR taper. By way of example metal layer's 202 shall be masked with a smaller aperture than in 203, which in turn will have a smaller aperture in 204, which in turn has a smaller aperture in barrier material 230. Such process will allow using a single etch process type through waveguide layers 211, 212, and 213 which may be semiconductor regions or transparent core layers, and through coating layers to be precisely tapered and aligned. Substrate 12801 has an optional base metal layer 201 performing also as etch barrier material, defining the bottom of the CRTR. Further optionally, signal media 107 may deposited on metal layer 201 which may serve as an etch barrier, to signal completion of etch. A semiconductor etch process etching through barrier material 230 will realign at the aperture in metal layer 204, and so forth. Thus the initial width of the CRTR in each semiconductor layer and its alignment with the image sensors or light sources in the waveguides adjacent thereto will be determined by the aperture masked into the metal layer immediately above it.

Evaporative and sublimation-based methods are acceptable for small molecule layer formation; however deposition of layers that are on the order of 5-20 molecules long may benefit from self-assembly methods as shown in FIG. 13.

FIG. 13 depicts a cross section of a proposed waveguide constructed using the dimensions and materials as described above. Material deposition may be accomplished by any desired method, such as low vacuum evaporation, ink jet printing of solutions, and roll-coating, by way of example, as well as numerous other processes known in the art. An anodic metal layer 1440 is deposited on sheet material 1430, which may comprise a substrate, or a portion of a stratum. A controlled length oligomer such as oligo-BPhen is disposed as layer 1450 of electron transport material. Functional groups 1451 and 1452 are disposed at opposite surfaces of the oligomer forming the electron transport layer 1450, wherein functional group 1451 is the reactive with the anodic metal and functional group 1452 is inert to the anodic metal. Self-assembly of a monolayer of such material will result and the material is preferably formed at about one half of the excess thickness, defined as the difference between the waveguide thickness and the sum of the acceptor and donor thicknesses. The residual, unreacted oligomer is rinsed.

If desired, a light or heat activated functional group 1453 is disposed intermediate to the terminal ends of functional groups 1451 and 1452, such that cross-linkage between oligomers occurs.

An acceptor material 1460, such as PCBM, is then disposed with a thickness of approximately a single diffusion length and preferably not more than five diffusion lengths. A donor material 1470, such as P3HT, is disposed with a thickness of approximately a single diffusion length and preferably not more than five diffusion lengths. A hole transport material 1480, such as PEDOT:PSS with a thickness comprising the remainder of the waveguide thickness. Finally a cathodic metal layer 1490 is disposed, completing the waveguide. Functional groups 1461 and 1462 provide similar functionality to functional groups 1451 and 1452, and their equivalents may be formed between other layers, as will be clear to the skilled in the art. Additional layers may be disposed in a similar process.

Thicker layers may be formed using multiple repetitions of shorter length oligomers. Thus, while a 70 nm (60-mer) transparent electron or hole transfer layer is desired for 330-530 nm, these layers may be as thick as 120 nm, 185 nm, and 320 nm respectively for the longer wavelength bands. These would represent approximately 107-mer, 165-mer, and 285-mer layers respectively. A shorter building block and functional group conversion chemistry may be employed to allow a second oligomer 1450′ to be joined to a previously bound oligomer 1450, and so forth. Optionally, evaporative methods may be employed for the thicker layers with self-assembly methods being used only for the precise definition of the photoabsorber material.

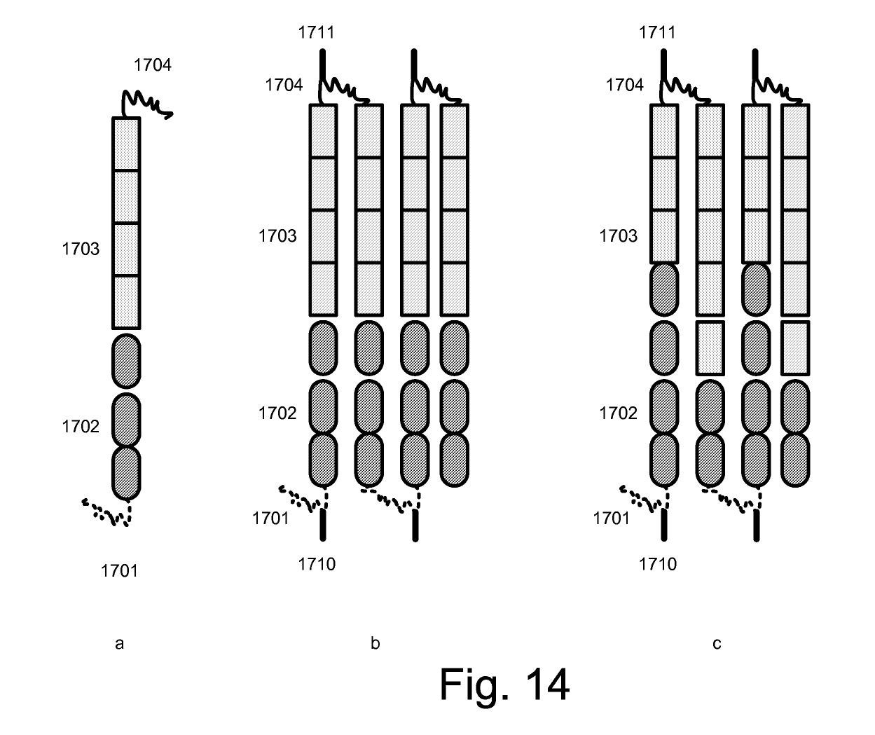

Since the repeat lengths for the acceptor and donor media are on the order of 5 to 20 monomers each, block co-polymer methods are attractive. FIG. 14a depicts a general sequence EₘAₙDₚH_{q} defines m repeats of electron conductor monomer “E” 1701, n repeats of acceptor monomer “A” 1702, p repeats of donor monomer “D” 1703, and q repeats of hole conductor “H” 1704. Such block co-polymers could form self-assembled monolayers on either an electron or hole transparent conductor.

FIG. 14b depicts an alternative constructions using block co-polymers which perform a repeated pattern, -EₘAₙDₚH_{q}DₚAₙ-, such that the hole and electron transparent conductor regions could hinge, allowing self-assembly over large numbers or repeats of the polymer. Optional reactive branches 1710 and 1711 could be reactive with compatible linkage ligands on the adjacent bulk conductor regions.

in certain embodiments it is desirable for the acceptor and donor layers to form an inter-mixed junction as shown in FIG. 14c. This is accomplished by varying the proportions of A and D on the up and down segments, as -EₘAₙDₚH_{q}DᵣAₛ-, such that the boundary between A and D is staggered.

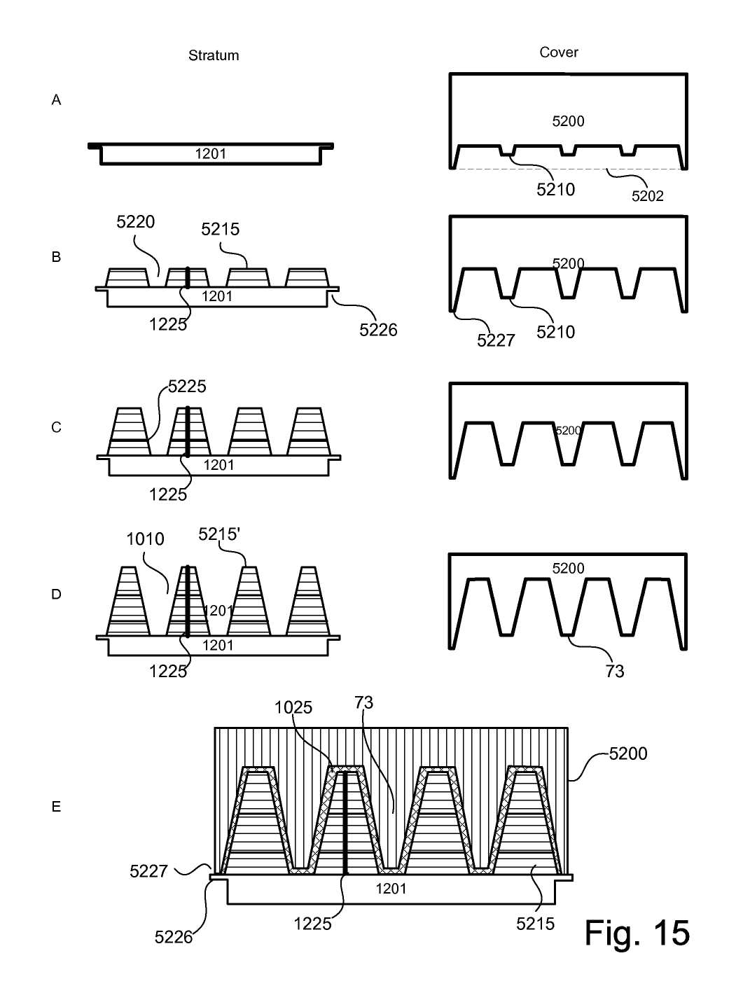

FIG. 15 depicts a simplified diagram of stages in an optional manufacturing method of CRTRs and strata. In stages A-D the stratum is shown on the left side, and a cover or a stamp tool on the right. The cover is akin to the stamp tool disclosed in other embodiments, however as in this embodiment it is designed to form a portion of the final device, the term cover is selected.

A substrate 1201 is provided as a base for the stratum, and a slab of material transmissive of radiant energy within the spectral range of interest is provided for the cover, as shown in FIG. 15 A. The cover begins as a simple slab, as indicated by the dashed line 202, and portions of the slab material are being removed until protrusion 5210 are formed. The protrusions will become the CRTR cores, and are thus dimensioned appropriately. FIG. 15 B depicts a first deposition of layers of the lateral waveguides 5215 on the substrate, and the initial formation 5210 of the CRTR tapered cores in the cover. The CRTR pits also begin to form 5220. The deposition may be carried out using any desired deposition method, which may include steps that will be clear to the skilled in the art such as depositing and patterning masks, epitaxial, molecular beam, atomic layer epitaxy, chemical deposition, and the like. The figure also depicts an optional growth of a baffle 1225 which will separate the stratum into compartments to form regions which may be as small as individual pixels. On the cover, protrusions 5210 are more defined, as more material is being removed about them. It is noted that in certain embodiments the cover is not homogenous, and may be created from several materials, and it must be transmissive to the spectral components which will pass therethrough. However different levels of the CRTR core may have different transmission characteristics at different depths.

FIG. 15 C depicts but one more growth stage of FIG. 15 B, however in a lateral layered waveguide type stratum, it also shows the optional formation of waveguide, where metal layer 5225 forms one cladding layer for a lateral waveguide.

The deposition process may be repeated as many times as required, until, as shown in FIG. 15 D, the desired shape and height is reached the stratum. Similarly, the removal of the material from the cover may continue as well, until the protrusions 5210′ are of appropriate dimensions to serve as CRTR cores. At that final depositions stage the lateral waveguides 5215′ are fully formed on the stratum, together with any desired transducers, cladding, protective layers, circuitry and the like. The formation of the lateral waveguide also define the pits 1010 in which the CRTR cores will be disposed.

FIG. 15E depicts the substrate 1201 and cover 5200 being joined in registration, such that the protrusions 5210′ now act as CRTR core 73, which are disposed in the pits 1010 defined by the voids between the lateral waveguides 5215′. A dielectric material 1025 which will become the cladding or acts as an intermediary material, is deposited between the CRTR cores and stratum. The cladding material may be disposed prior to mating the stratum and the cover, or may be in the form of fluid which is flowed into the between the stratum and the cover. If desired such fluid may be hardened by temperature, radiant energy hardening, chemical hardening, and the like, If desired seal areas 5226, 5227 are used to provide a seal between the stratum and the cover.

Optionally the cover may be created in an upside-down manner, where material of the cover slab is being removed to form an inverted mesa, and the protrusions that will form the CRTR cores are grown on the inverted mesa by any desired process, until they reach the desired dimensions.

Material selection for several waveguide based transducers is provided hereinunder by way of non-limiting example, to assist the practitioner in designing and practicing this aspect of the invention. A layer comprising amorphous silicon offers bandgap energies of about 1.7 eV (0.730 μm) while another layer of poly-silicon or single crystal silicon offers a lower bandgap of 1.1 eV (1.127 μm) and germanium allows 0.67 eV (1.851 μm). Indium gallium arsenide can be selectively varied from 0.36 to 1.43 eV (3.444-0.867 μm), gallium arsenide phosphide can be selectively varied from 1.43 to 2.26 eV (0.549-0.867 μm), aluminum indium arsenide can be varied from 0.36 to 2.16 eV (0.574-3.444 μm), indium gallium nitride can be varied from 2 to 3.4 eV (0.365-0.620 μm), aluminum gallium nitride can be varied from 3.44 to 6.28 eV (0.197-0.360 μm) and silicon-germanium alloys can be varied from 0.67 to 1.1 eV (1.127-1.851 μm). The family of Transition Metal Dichalcogenides such as molybdenum disulfide MoS2, and tungsten diselenide, and the like also show promise as transducers. The vast combinations of alloys and junction combinations are a matter of technical choice. Clearly, tailored bandgaps can be selected from 0.36 eV (3.44 μm) or deeper into the infra-red to 6.28 eV (0.197 μm) or higher into the ultraviolet.

The skilled in the art would recognize that organic and inorganic transducers utilize different mechanisms. In the case of organic polymer based detectors, the transducer comprises electron acceptor and photo-absorptive electron donor semiconductor layers. The optical absorption energy of the donor preferably corresponds to a wave frequency approximately equal to the cutoff frequency of its lateral waveguide. Heterojunctions between acceptor and donor produces the photovoltaic output. When relating to polymer based detectors, the interface between the electron donor and the acceptor may be considered a junction for practical purposes, whether they form a hetrojunction or not. For the purposes of the transducers relating to the present invention, these differences may be ignored, and a method, technique, or apparatus described as one is equally applicable to another.

There are several developmental large bandgap organic semiconductors, with one of the most mature being poly(3-hexylthiophene), P3HT, in a heterojunction with [6,6]-phenyl-C₆₁-butyric acid methyl ester (PCBM), obtaining a 5% efficiency. The bandgap of P3HT is around 1.9 eV, limiting the absorbance to below a wavelength of 650 nm. At 650 nm only about 20% of the total amount of photons can be harvested, hence decreasing the bandgap increases the total amount of photons that can be harvested from the solar spectrum.

“Small Bandgap Polymers for Organic Solar Cells (Polymer Material Development in the Last 5 Years), by R. Kroon, M. Lenes, J. Hummelen, P. W. M. Blom, and B. de Boer, Polymer Reviews, 48:531-582, 2008 discusses the efficiency factors of organic semiconductor materials and discusses the need for lower bandgap materials.

The preferred waveguide thickness of a waveguide based detector is dependent on the minimum energy and also on the dielectric constant of the semiconductor. Relative dielectric constants of semiconductors range from about 9 for AlₓGa₁₋ₓN, 12 for silicon to about 18 for InSb. For providing a nonlimiting design example for solar radiant energy, free space wavelength of 300 nm is considered as an upper limit of interest. 300 nm radiation has a wavelength of 100 nm in AlₓGa₁₋ₓN, yielding 50 nm as the cutoff point for propagation of such radiant energy through the guide. Selecting a waveguide thickness slightly thicker than the cutoff value is appropriate. The wavelength of 3.3 μm is considered a lower limit of interest for the present example. 3.3 μm radiation has a wavelength of slightly less than 1 μm in InₓAl₁₋ₓAs, yielding 500 nm as the cutoff point for propagation of such radiant energy through the guide.

In order to provide additional guidance, examples of design consideration is provided hereinunder for a single lateral waveguide forming a portion of a lateral waveguide stratum for energy harvesting application. A stratum having four lateral waveguides is considered, with band cutoffs at 530 nm, 850 nm, 1350 nm, and 2150 nm respectively. The critical lateral waveguide thickness (λₐᵢᵣ/2n) is given and a 10% precision margin is arbitrarily selected. Table 1 tabulates the minimum waveguide thicknesses for an organic photovoltaic material with index of refraction on the order of 1.8. To provide a sensor of molecular scales, the dimensions are also given in numbers of carbon-to-carbon bond lengths in a simple polymer. Since a very common family of photoabsorbtive materials use the buckminsterfullerene (“buckeyball”) based small molecules, the dimension is also given in terms of number of buckeyballs thick. Since the lateral waveguide aperture size ψL in such embodiments needs to be slightly larger than the critical aperture size to allow for manufacturing variations, target lateral waveguide thicknesses of approximately 165 nm, 260 nm, 415 nm, and 660 nm respectively, for typical organic semiconductor materials with index of refraction n values averaging 1.8, are obtained by way of non-limiting example.

TABLE 1

| | Band (λ, nm in air) | | | |
|---|---|---|---|---|
| | 330-530 | 530-850 | 850-1350 | 1350-2150 |
| λₐᵢᵣ/2n (n = 1.8) | | | | |
| in C-C bond lengths | 147 | 236 | 375 | 597 |
| in buckeyball | 1052 | 1687 | 2679 | 4266 |
| diameters | 210 | 337 | 536 | 853 |

The following waveguide design example is provided to exemplify a design process for lateral waveguides. The design example is directed at the 330-530 nanometer band. One organic photoabsorber donor that is efficient below 530 nm is poly-3-hexylthiophene (P3HT). Zinc phthallocyanide (ZnPc) absorbs strongly in the 530-850 nm band. Other photoabsorbers and dyes exist in longer wavelengths and the methods and required calculations for each can be suitably illustrated by the following example for the 330-530 nm band.

A 200 nm-thick P3HT layer is required to absorb at least 95% of the incident light energy in the intrinsic absorption wavelength range without waveguiding. These dimensions are large compared to the intrinsically short diffusion length of excitons in organic semiconductors, which are typically around 15 nm, about 14 monomers long for P3HT.

Another organic polymer with good absorption from 370 nm to 660 nm is the buckminster-fullerene acceptor material, [6,6]-phenyl-C61-butyric acid methyl ester (PCBM). It is reported to have an even smaller diffusion length—perhaps as low as 5 nm, on the order of 7 monomers in length or 1/30th of the waveguide thickness.

A figure of merit for vertical incidence of light on a planar junction is the product of the absorbance and the diffusion length, which is quite low for organic semiconductors. It would be beneficial if the absorptive layers were to be limited to approximately one diffusion length or at least a small multiple thereof. Lateral energy paths which propagate along the junction between the semiconductors overcome this problem and allow the absorptive region to be centered vertically in the waveguide. Combining 5 nm of PCBM and 15 nm of P3HT results in a 20 nm absorber thickness. Assuming therefore absorber thickness of 20 nm vs. a required length of 200 nm for complete absorption, a 2 μm long section of waveguide containing such absorber in only 10% of its volume should still provide 95% photon capture in 2 μm of waveguide length.

The design assumes a waveguide thickness of 165 nm, and thus the remaining 145 nm of the overall thickness of the waveguide needs to be optically transparent to provide the required waveguide thickness. On the other hand, the remaining 145 nm of waveguide thickness needs good vertical electrical conductivity.

Poly(3,4-ethylenedioxythiophene) (PEDOT), typically as a co-polymer with poly(styrene-sulfonate) (PSS), is a good transparent conductor for hole injection (hole transport layer) from an organic solar cell or light emitting diode. It typically has a 0.01-0.1 Ω-m resistivity. About 75 nm thickness will occupy one half of the space to be filled in the waveguide and has a ˜10⁵ resistance through a 1 cm² area despite its large sheet resistance. Other electron transport materials offer similar properties. One such material is small molecule 4,7-diphenyl-1,10-phenanthroline (BPhen), which has a monomer length of about 1.2 nm. It is transparent over a wide range of wavelengths with a relatively stable index of refraction of 1.7 to 1.8 over much of the range from 400 nm to 800 nm and beyond. Another suitable hole transport material is dinaphtho[2,3-b:2′,3′-f]thieno[3,2-b]thiophene (DNTT), which has a 1.7 nm monomer length and forms rod-like crystals with good carrier mobility.

It will be appreciated that the invention is not limited to what has been described hereinabove merely by way of example. While there have been described what are at present considered to be the preferred embodiments of this invention, it will be obvious to those skilled in the art that various other embodiments, changes, and modifications may be made therein without departing from the spirit or scope of this invention and that it is, therefore, aimed to cover all such changes and modifications as fall within the true spirit and scope of the invention, for which letters patent is applied.

1. A method of making a stratum having a plurality of superposed waveguides, the method comprising the steps of:
providing at least a first and a second waveguides disposed at least partially in superposed relationship therebetween, each waveguide comprising:
a core layer and an upper and a lower metal cladding layers disposed respectively on opposite sides of the core layer, the core layer having at least one energy transducer disposed therein;
wherein the core layer being substantially transparent to radiant energy impinging thereupon; the core having a transducer disposed therein, the transducer having at least a first and a second layers of differing materials selected from optical dielectric material, conductive material, electron donor material, electron acceptor material, and any combination thereof, the first and second layers having a P-N junction guided by the waveguide would propagate in the general lengthwise direction of the junction; and,
wherein each waveguide thickness is dimensioned to optimize guiding of energy within the range of energy convertible by the transducer.

2. A method of making a stratum as claimed in claim 1, wherein the transducer having bandgap energy slightly higher than the energy associated with radiant energy of the lowest frequency which can propagate in the respective waveguide.

3. A method of making a stratum as claimed in claim 1, wherein a transducer disposed in the first waveguide has a different bandgap energy than the bandgap energy of a transducer disposed in the second waveguide.

4. A method of making a stratum as claimed in claim 1, further comprising providing at least one charge transport layer disposed between the cladding layers and at least one of the first and second core layers.

5. A method of making a stratum as claimed in claim 1, wherein the cladding layers comprise metal layers, the at least one cladding layer serves as electrode to a transducer at least partially disposed in the waveguide.

6. A method of making a stratum as claimed in claim 1, further comprising at least one insulator, disposed between the cladding layer of one waveguide and the waveguide disposed thereabove.

7. A method of making a stratum as claimed in claim 1, wherein the cladding layers comprise metal layers, and wherein the cladding layers of two adjacently superposed waveguides are formed by a single cladding layer, and wherein the single cladding layer serves as cladding to a side of both adjacent waveguides.

8. A method for forming tapered core waveguides in a stratum, the method comprising:
forming pits within the stratum, the pits having walls;
disposing core material at least partially within the pit; and,
disposing cladding material between the core and at least one walk;
wherein the cladding material is a fluid, is malleable, or a combination thereof.

9. A method as claimed in claim 8, wherein the cladding comprises metal cladding, such that the cladding comprises a metallic layer thinner than the local skin depth thereof.

10. A method as claimed in claim 9, wherein the cladding comprises metal cladding having a thickness sufficiently small to form porous or discontinuous layer.

11. A method as claimed in claim 9, further comprising the step of disposing dielectric material between the pit walls and the cladding.

12. A method as claimed in claim 8, wherein the cladding comprises a material having lower refractive index than a material forming the core.

13. A method as claimed claim 8, wherein the pits are formed in a process selected from wet etch, plasma etch, reactive ion etch, LIGA (Lithographie, Galvanoformung, Abformung), ion milling, focused ion beam (FIB) lithography, Laser Photo Ablation, or any combination thereof.

14. A method as claimed claim 8 further comprising the steps of
providing a stamp tool having a plurality of protrusions extending therefrom, the protrusions dimensioned at least in part as the tapered waveguide cores;
aligning the stamp tool with the pits; and,
inserting the stamp tool into the pits.

15. The method as claimed in claim 14, wherein the stamp tool comprises material transmissive to a spectral range of interest of the tapered core waveguide, and wherein the stamp tool is left integrated within the stratum.

16. The method as claimed in claim 15, wherein the stamp tool forms a lens.

17. The method as claimed in claim 12, wherein the cladding is disposed in fluid form and further comprising the step of solidifying the cladding.

18. The method as claimed in claim 8, further comprising the step of forming a lens over a plurality of the pits.

19. The method as claimed 8, further comprising the step of disposing a collimation layer over the cores, wherein at least one collimator is disposed over a single core.

20-29. (canceled)
